(19) United States
(12) Patent Application Publication
(10) Pub. No.: US 2026/0261944 A1
(43) Pub. Date: Sep. 3, 2026

(54) PUBLIC LAND MOBILE NETWORK/CELL SELECTION BASED ON FEEDER LINK AVAILABILITY

(71) Applicant: SAMSUNG ELECTRONICS CO., LTD., Suwon-si (KR)

(72) Inventors: Lalith KUMAR, Bangalore (IN); Aman AGARWAL, Bangalore (IN); Sidhant JAIN, Bangalore (IN); Dinesh Rooparam CHOUDHARY, Bangalore (IN); Utsav SINHA, Bangalore (IN)

(21) Appl. No.: 19/659,604

(22) Filed: Apr. 27, 2026

Related U.S. Application Data
(63) Continuation of application No. PCT/KR2024/016473, filed on Oct. 25, 2024.

(30) Foreign Application Priority Data
Oct. 27, 2023 (IN) 202341073205
Nov. 2, 2023 (IN) 202341074635
Oct. 14, 2024 (IN) 202341073205

(51) Int. Cl. H04W 36/22; H04W 84/04

(52) U.S. Cl. CPC H04W 36/22; H04W 84/042

(57) ABSTRACT

A method for PLMN/cell selection or reselection based on the feeder link availability is provided. A system and a method for managing a Public Land Mobile Network (PLMN) selection, cell selection and/or reselection for a Store and Forward (S&F) mode in a wireless network system is provided. The method comprises the UE determining that a first cell supports S&F mode and a feeder link is unavailable. The UE performs a PLMN selection, a cell selection, and/or a cell reselection in the wireless network system to search for a second cell, wherein the feeder link is available on the second cell and a network apparatus associated with the UE is able to provide normal services to the UE.

### CROSS-REFERENCE TO RELATED APPLICATIONS

This application is a continuation of International Application No. PCT/KR2024/016473 designating the United States, filed on Oct. 25, 2024, in the Korean Intellectual Property Receiving Office and claiming priority to Indian Provisional Patent Application No. 202341073205, filed on Oct. 27, 2023, Indian Provisional Patent Application No. 202341074635, filed on Nov. 2, 2023, and Indian Complete Patent Application No. 202341073205, filed on Oct. 14, 2024, in the Indian Patent Office, the disclosures of each of which are incorporated by reference herein in their entireties.

### BACKGROUND

### Field

The disclosure relates to wireless communication and for example relates to a method and system for a public land mobile network (PLMN)/cell selection based on feeder link availability.

### Description of Related Art

The advent of 5^{th} generation (5G) communications has heralded significant advancements in global communication infrastructure, particularly through the integration of non-terrestrial network (NTN) and terrestrial network (TN). NTNs, which encompass satellite and high-altitude platform systems, offer expansive coverage that complements traditional terrestrial systems. The operational dynamics of NTNs and TNs within the 5G framework can be optimized through their use of either distinct or overlapping frequency bands. The 5G system supports service continuity between new radio (NR) terrestrial access networks and NR satellite access networks, whether owned by the same operator or by different operators having an agreement. NTNs and TNs can operate in separate frequency bands (e.g., FR1 vs. FR2) or within the same frequency band (e.g., frequency range 1 (FR1) or FR2).

The integration of satellite systems within the 5G framework, as well as in legacy systems like 4^{th} generation (4G), presents several challenges. Satellite access, defined broadly to include 5G NR satellite access and other radio access technologies (RATs) with satellite access, offers benefits but also introduces complexities. The terms satellite 3^{rd} generation partnership project (3GPP) access, satellite access, satellite access network, NR satellite access network, satellite next generation (NG)-radio access network (RAN) access technology, and NR satellite access are used interchangeably and share the same meaning.

In conventional methods, when a UE receives an acceptable signal strength from a cell, it remains camped on that cell to receive services. The UE assumes that it can receive services from that cell or network apparatus. However, if the feeder link to the satellite is unavailable, the next generation node base station (gNB) or network functions embedded on the satellite cannot connect to the ground, thus limiting the services provided to the user equipment (UE). In such scenarios, the UE may receive Store and Forward (S&F) mode services or delay-tolerant services, which may not meet the UE's requirements.

The S&F operation mode necessitates support from both the UE and the network apparatus. UEs that do not support S&F is restricted from accessing satellites that provide such services. For example, an older UE sending data to a satellite supporting S&F might expect an acknowledgment or response within a specific time window. Failure to receive such acknowledgment or response could be interpreted as a failure to send the data, thus disrupting the procedure at the UE level. Consequently, such UEs is restricted from accessing satellites supporting S&F to avoid overloading the satellite and ensuring that legitimate UEs capable of supporting S&F can utilize the functionality effectively.

Therefore, mechanisms are needed to restrict older UEs from accessing satellite systems that support S&F functionality. Additionally, UEs that support S&F must be able to identify satellites capable of providing S&F services. Addressing these challenges is needed to optimize the integration of NTNs and TNs within the 5G framework and ensure seamless service delivery to the UEs.

Thus, there is a need to address the aforementioned disadvantages, issues, and other shortcomings, or at least provide a useful alternative.

### SUMMARY

According to an example embodiment, a method for managing a network (re-)selection for a store & forward (S&F) mode in a wireless network system is provided. The method comprises: the user equipment (UE) determining that a first cell supports S&F mode and a feeder link is unavailable; the UE performing a public land mobile network (PLMN) selection, a cell selection, or a cell reselection in the wireless network system to search for a second cell wherein the feeder link is available on the second cell, wherein a network apparatus associated with the UE is able to provide normal services to the UE.

In an example embodiment, the method comprises determining by the UE whether the second cell is available, and the UE camps and registers on the second cell in response to determining that the second cell is available.

In an example embodiment, the method comprises determining by the UE whether the second cell is available, and the UE camps and registers on the first cell in response to determining that the second cell is unavailable.

In an example embodiment, the method comprises: determining by the UE whether a timer expires when the UE is registered for normal services on a second cell. The UE initiates a search for a higher priority PLMN upon expiration of the timer. The UE determines whether a cell associated with the higher priority PLMN is a first cell based on the higher priority PLMN being available based on the search. The UE ignores and skips at least one of the first cell associated with the higher priority PLMN, a tracking area identifier (TAI) associated with the first cell, or a PLMN associated with the first cell. The UE performs one of continuing the search for any other higher priority PLMN available in the wireless network system for selection that is not the first cell and to get services on the current second cell in the absence of any other higher priority PLMN that is not the first cell and can provide normal services.

In an example embodiment, the method includes: determining by the UE whether a timer expires when the UE is on the first cell, and the UE initiates a search for a higher priority PLMN upon expiration of the timer. The UE initiates the search for a higher priority PLMN that can provide S&F services to the UE or at least one of the higher priority PLMN and lower priority PLMN that can provide normal services to the UE.

In an example embodiment, the UE is configured to perform the search for at least one of the higher or lower priority cells capable of providing normal service to the UE even when the UE is registered for a higher priority cell in response to determining that the UE is registered on the first cell.

In an example embodiment, determining the feeder link is unavailable by the UE includes: determining by the UE that the feeder link is unavailable based on the network apparatus broadcasting the support of S&F mode (or any other indication which indicates to the UE that feeder link is currently unavailable as part of broadcast signal or access stratum (AS) or non-access stratum (NAS) message; and determining that the feeder link is available when the network does not broadcast support of S&F mode (or any other indication which indicates to the UE that feeder link is currently available as part of broadcast signal or AS or NAS message).

According to an example embodiment, a method for managing PLMN selection, cell selection, or reselection for S&F modes in a wireless network system includes: determining by the network apparatus whether a feeder link is available and the network apparatus supports the S&F mode; the network apparatus broadcasting a signal message to the UE indicating to the UE that the network apparatus is operating in the S&F mode based on the feeder link being unavailable and the network apparatus supporting the S&F mode; and based on the network apparatus determining the feeder link is unavailable and the network apparatus not supporting the S&F mode, the network apparatus is switched off and the broadcast of the signal message from the network apparatus is stopped.

According to an example embodiment, a UE for managing PLMN selection, cell selection, or reselection for S&F modes in a wireless network system is provided. The UE includes: a memory comprising information about the availability of the feeder link and the ability to perform S&F mode and at least one processor, comprising processing circuitry; an S&F controller, comprising circuitry coupled to the memory and at least one processor, wherein the UE is configured to: determine that a first cell supports the S&F mode and a feeder link is unavailable; the S&F controller is configured to perform a PLMN selection, a cell selection, or a cell reselection in the wireless network system to search for a second cell wherein the feeder link is available on the second cell, and a network apparatus associated with the UE is able to provide normal services to the LE.

According to an example embodiment, a network apparatus for managing PLMN selection, cell selection, or reselection for S&F modes in a wireless network system is provided. The network apparatus includes: a memory comprising information about the availability of the feeder link and the ability to perform S&F mode; a processor, comprising processing circuitry, and a S&F controller, comprising circuitry, coupled to the memory and at least one processor, wherein the S&F controller is configured to: determine whether a feeder link is available and the network apparatus supports the S&F mode; based on the feeder link being unavailable and the network apparatus supporting the S&F mode, the network apparatus is configured to broadcast the signal message to the UE indicating to the UE that the network apparatus is operating in the S&F mode; and based on the network apparatus determining the feeder link is unavailable and the network apparatus not supporting the S&F mode, the network apparatus is configured to switch off the network apparatus and stop the broadcast of the signal message from the network apparatus.

These and other aspects of the disclosure will be better appreciated and understood when considered in conjunction with the following description and the accompanying drawings. It is understood, however, that the following descriptions, while indicating various example embodiments and numerous specific details thereof, are given by way of illustration and not of limitation. Many changes and modifications be made within the scope of the disclosure herein without departing from the spirit thereof, and the disclosure includes all such modifications.

### BRIEF DESCRIPTION OF THE DRAWINGS

The above and other features, aspects, and advantages of certain embodiments of the present disclosure are illustrated in the accompanying drawings, throughout which like reference letters indicate corresponding parts in the various figures and will be more apparent from the following detailed description, taken in conjunction with the accompanying drawings, in which:

FIG. 1 is a diagram illustrating Store and Forward (S&F) operation of a 5^{th} generation (5G) system with satellite access where the link between the user equipment (UE) and the satellite network cell and between the Satellite and the network apparatus are not connected at the same point of time according to the prior art.

FIG. 2 is a diagram illustrating signaling/data traffic exchange between the UE and the network apparatus under normal/default service according to the prior art.

FIG. 3 is a diagram illustrating end-to-end signaling/data traffic exchange between the UE and the network apparatus through the satellite network in S&F operation mode according to the prior art.

FIG. 4 is a diagram illustrating hollow networks where the network apparatus does not support S&F mode and there is no feeder link available between the satellite network and the ground station according to the prior art.

FIG. 5A is a block diagram illustrating an example configuration of a UE according to various embodiments.

FIG. 5B is a block diagram illustrating an example configuration of a network apparatus according to various embodiments.

FIG. 6A is a signal flow diagram illustrating an example scenario of network apparatus indicating the unavailability of the feeder link according to various embodiments.

FIG. 6B is a signal flow diagram illustrating an example scenario of network apparatus indicating the availability of the feeder link according to various embodiments.

FIG. 7 is a signal flow diagram illustrating an example scenario of the network apparatus indicating the feeder link availability information to the UE according to various embodiments.

FIG. 8 is a diagram illustrating a UE connected to a cell having the feeder link according to various embodiments.

FIG. 9 is a diagram illustrating a UE connected to a cell without feeder link and which does not support S&F according to various embodiments.

FIG. 10 is a flowchart illustrating an example method for managing the PLMN selection, cell selection, or reselection for S&F mode in a wireless network system according to various embodiments.

FIG. 11 is a signal flow diagram illustrating a scenario of the UE without S&F support accessing the cell that supports the S&F operation mode according to the prior art.

FIG. 12 is a signal flow diagram illustrating an example scenario of restriction of the UE which does not support S&F functionality from accessing satellites which support S&F operation mode based on cell access according to various embodiments.

FIG. 13 is a signal flow diagram illustrating an example scenario of the network apparatus identifying the UE which supports the S&F operation mode based on the indication by the UE according to various embodiments.

FIG. 14 is a signal flow diagram illustrating an example scenario where the UE with no S&F functionality is restricted to access the cell which supports only S&F operation mode according to various embodiments.

FIG. 15 is a signal flow diagram illustrating an example scenario of the UE that supports S&F operation mode accessing both the cells supporting S&F operation modes and also the cells that support normal services according to various embodiments.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show those specific details that are pertinent to the understanding the various embodiments of the disclosure so as not to obscure the drawing with details that will be readily apparent to those of ordinary skill in the art having benefit of the description herein.

### DETAILED DESCRIPTION

The various example embodiments herein and the various features and advantageous details thereof are explained more fully with reference to the non-limiting example embodiments that are illustrated in the accompanying drawings and described in the following description. Descriptions of well-known components and processing techniques may be omitted so as to not unnecessarily obscure the disclosure herein. The various embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the disclosure can be practiced. Accordingly, the examples are not to be understood as limiting the scope of the disclosure.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments be physically separated into two or more interacting and discrete blocks without departing from the scope of the disclosed method. Likewise, the blocks of the various embodiments be physically combined into more complex blocks without departing from the scope of the disclosed method.

The accompanying drawings are used to help easily understand various technical features and it is understood that the disclosure is not limited by the accompanying drawings. As such, the disclosed methods are understood to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

According to various embodiments of the disclosure, communication devices are used to provide a system and method for a public land mobile network (PLMN)/cell selection or reselection based on the feeder link availability.

According to various embodiments of the disclosure, communication devices are used to identify and register to the suitable cell based on factors like feeder link availability and the ability of the cell to provide services in store & forward (S&F) mode.

According to various embodiments of the disclosure, communication devices are used to perform continuous monitoring of the serving cell and register on another available cell which can provide normal services.

According to various embodiments of the disclosure, communication devices are used to provide optimal connectivity and to enhance service quality.

According to various embodiments of the disclosure, communication devices are used to restrict the UE which does not support the S&F operation mode from accessing the satellite that supports the S&F operation.

According to various embodiments a method for managing a PLMN selection, cell selection, or reselection for an S&F mode in a wireless network system is provided. The method comprises the user equipment (UE) determining that a first cell supports S&F mode and a feeder link is unavailable. Further, the UE performs a PLMN selection, a cell selection, or a cell reselection in the wireless network system to search for a second cell wherein the feeder link is available on the second cell and a network apparatus associated with the UE is able to provide normal services to the UE.

According to various embodiments, a method for managing PLMN selection, cell selection, or reselection for S&F modes in a wireless network system may include determining by the network apparatus whether a feeder link is available and the network apparatus supports the S&F mode. Further, the network apparatus broadcasts a signal message to the UE indicating to the UE that the network apparatus is operating in the S&F mode when the feeder link is unavailable and the network apparatus supports the S&F mode. Further, when the network apparatus determines the feeder link is unavailable and the network apparatus does not support the S&F mode, the network apparatus is switched off and the broadcast of the signal message from the network apparatus is stopped.

According to an example embodiment, a UE for managing PLMN selection, cell selection, or reselection for S&F modes in a wireless network system is provided. The UE includes a memory comprising information about the availability of a feeder link and the ability to perform S&F mode and a processor. Further, the UE includes an S&F controller coupled to the memory and the processor. The UE is configured to determine that a first cell supports the S&F mode and a feeder link is unavailable. Further, the S&F controller performs a PLMN selection, a cell selection, or a cell reselection in the wireless network system to search for a second cell wherein the feeder link is available on the second cell and a network apparatus associated with the UE is able to provide normal services to the UE.

According to various embodiments, a network apparatus for managing PLMN selection, cell selection, or reselection for S&F modes in a wireless network system is provided. The network apparatus includes a memory comprising information about the availability of a feeder link and the ability to perform S&F mode and a processor. Further, the network apparatus includes the S&F controller coupled to the memory and the processor. The S&F controller is configured to determine whether a feeder link is available and the network apparatus supports the S&F mode. When the feeder link is unavailable and the network apparatus supports the S&F mode, the network apparatus broadcasts the signal message to the UE indicating to the UE that the network apparatus is operating in the S&F mode. Further, when the network apparatus determines the feeder link is unavailable and the network apparatus does not support the S&F mode, the network apparatus switches off the network apparatus and stops the broadcast of the signal message from the network apparatus.

The network (re-)selection as described in the disclosure may be associated with one of cell selection, cell reselection, PLMN selection and others. Further the cell as described in the disclosure is associated with the area served by the ground station or satellite networks to describe the coverage areas of the satellite beams enabling the UE to connect to the wireless network system.

An example list of NAS messages may include, but is not limited to, REGISTRATION REQUEST message, DEREGISTRATION REQUEST message; SERVICE REQUEST message, CONTROL PLANE SERVICE REQUEST, IDENTITY REQUEST, AUTHENTICATION REQUEST, AUTHENTICATION RESULT, AUTHENTICATION REJECT, REGISTRATION REJECT, DEREGISTRATION ACCEPT; SERVICE REJECT, SERVICE ACCEPT, ATTACH REQUEST message, ATTACH ACCEPT message, ATTACH REJECT message, Tracking Area UPDATE Request message, TRACKING AREA UPDATE ACCEPT message, Tracking AREA UPDATE REJECT message, DETACH REQUEST message, DETACH ACCEPT message, DETACH REJECT message, or any messages as defined in 3GPP and so on.

In an embodiment, the satellite refers to an artificial body placed in orbit round the earth or moon or another planet in order to collect information or for communication. satellite constellation is a group of satellites, placed in orbit round the earth or moon or another planet in order to collect information or for communication. Further service user refers to an individual who has received a priority level assignment from a regional/national authority (i.e., an agency authorised to issue priority assignments) and has a subscription to a mobile network operator.

The EMM (EPS Mobility Management) sublayer is part of the NAS layer in the 5G architecture, managing the mobility and connection states of the UE. In the disclosure the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The 5GMM (5G Mobility Management) sublayer which is a part of the 5G core network architecture and plays an important role in managing mobility and session management for UE. The term 5GMM sublayer state in this disclosure is at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED
VPLMN: This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell selection/reselection process and has chosen a cell from which it plans to receive available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list replaces the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it is treated as a Visited PLMN for PLMN selection purposes.

Home PLMN: This is a PLMN where the Mobile Country Code (MCC) and Monile Network Code (MNC) of the PLMN identity match the MCC and MNC of the International Mobile Subscriber Identity (IMSI).

RPLMN: This is the PLMN on which LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

The Radio Access Technology (RAT) facilitates the wireless communication between the UE and the network apparatus via radio waves. The RAT defines the protocols, modulation schemes, and frequency bands used for transmitting voice, data, and control signals. This is used in determining network performance, capacity, and coverage. The term RAT, as defined in this embodiment, can be one of the NG-RAN, 5G, 4G, 3G, 2G, EPS, 5GS, NR, NR in unlicensed bands, NR(LEO) satellite access, NR(MEO) satellite access, NR(GEO) satellite access, NR(OTHERSAT) satellite access, NRRedCap, E-UTRA, E-UTRA in unlicensed bands, NB-IoT, WB-IoT, LTE-M.

The 5G System (5GS) refers to the end-to-end architecture that supports 5G connectivity, encompassing both the radio access network (RAN) and the core network.

It is designed to deliver enhanced mobile broadband, ultra-reliable low-latency communication, and massive machine-type communication. The fundamental aspect of the 5GS is the registration process, which ensures that the UE can securely access the network apparatus, authenticate its identity, and maintain continuous service availability. The 5GS registration occurs whenever the UE connects to the network apparatus or moves between different areas within the network apparatus. The registration process allows the UE to establish communication with the core network, update its location, and ensure service continuity. The 5GS registration type can include any of initial registration, mobility registration updating, periodic registration updating, emergency registration, SNPN onboarding registration, disaster roaming initial registration, or disaster roaming mobility registration updating, and others.

The registration type to disaster roaming initial registration or disaster roaming mobility registration updating may refer, for example, to a 5GS registration type being set to a value other than disaster roaming initial registration or disaster roaming mobility registration updating at least one of initial registration, mobility registration updating, periodic registration updating, emergency registration, and SNPN onboarding registration.

PLMN selection without RPLMN: The MS selects and attempts registration on any PLMN/access technology combinations, if available and allowable, in the following order: a) either the HPLMN (if the EHPLMN list is not present or is empty) or the highest priority EHPLMN that is available (if the EHPLMN list is present), b) each PLMN/access technology combination in the “User Controlled PLMN Selector with Access Technology” data file in the SIM (in priority order), c) each PLMN/access technology combination in the “Operator Controlled PLMN Selector with Access Technology” data file in the SIM (in priority order) or stored in the ME (in priority order), d) other PLMN/access technology combinations with received high quality signal in random order, and e) Other PLMN/access technology combinations in order of decreasing signal quality.

PLMN selection with RPLMN: The MS selects and attempts registration on any PLMN/access technology combinations, if available and allowable, in the following order: a) either the RPLMN or the Last registered PLMN; b) either the HTPLMN (if the EHPLMN list is not present or is empty) or the highest priority EHPLMN that is available (if the EHPLMN list is present); c) each PLMN/access technology combination in the “User Controlled PLMN Selector with Access Technology” data file in the SIM (in priority order); d) each PLMN/access technology combination in the “Operator Controlled PLMN Selector with Access Technology” data file in the SIM (in priority order) or stored in the ME (in priority order): a) other PLMN/access technology combinations with received high quality signal in random order; and b) other PLMN/access technology combinations in order of decreasing signal quality.

SNPN selection include An MS may be enabled for SNPN. An MS enabled for SNPN may operate in SNPN access operation mode over 3GPP access. An MS may support on boarding services in SNPN. An MS enabled for SNPN may support access to an SNPN using credentials from a credentials holder. An MS enabled for SNPN may support access to an SNPN providing access for localized services in SNPN. If the MS supports access to an SNPN providing access for localized services in SNPN, the MS shall support access to an SNPN using credentials from a credentials holder. With the exception of on boarding services in SNPN, the MS operating in SNPN access operation mode over 3GPP access selects:
an SNPN for which it is configured with a subscriber identifier and credentials;
if the MS supports equivalent SNPNs, an equivalent SNPN; or
if the MS supports access to an SNPN using credentials from a credentials holder, an SNPN which supports access using credentials from a credentials holder.
The MS can have several sets of subscriber identifiers, credentials, SNPN identities, and other parameters related to SNPN selection. There are two modes for SNPN selection:
Automatic SNPN selection mode.
Manual SNPN selection mode.
For on boarding services in SNPN, the MS operating in SNPN access operation mode over 3GPP access selects an SNPN indicating that on boarding is allowed. There are two modes for SNPN selection for on boarding services in SNPN:
Automatic SNPN selection mode.
Manual SNPN selection mode.

The term PLMN selection in this disclosure may imply at least one of the PLMN selection without RPLMN or PLMN selection with RPLMN or the SNPN selection.

The network apparatus used in the disclosure can be explained using any 5G Core Network Function, for example, AMF. However, the network could be any 5G/EUTRAN Core Network Entities like AMF/SMF/MME/UPF, or the Network could be any 5G/EUTRAN RAN Entity like eNodeB (eNB) or gNodeB (gNB) or NG-RAN, etc. The messages used or indicated in this embodiment are shown as an example. The messages could be any signaling messages between UE and the Network Functions/Entities or between different Network functions/entities. The terms area/location/geographical area used in this embodiment may refer to any of cell/cell ID, TAC/TAI, PLMN, MCC/MNC, Latitude/longitude, CAG cell, or any geographical location/coordinate. The term ACK (or acknowledgment) in this embodiment should be treated as one of the NAS/AS messages.

For example, when the UE sends an Attach/TAU request message, MME-onboard the satellite may send the UE with attach accept or TAU accept with the minimal context MME/AMF is holding. Later, MME/AMF-onboard will deliver the NAS message to the ground MME/AMF. The ground MME/AMF will start executing the procedure, and once the procedure is executed, the MME/AMF will provide the attach accept/tau accept/registration accept message, which will have all the contents required by the UE to create the UE context.

A network function instance can be deployed such that several network function instances are present within an NF Set to provide distribution, redundancy, and scalability together as a Set of NF instances. The same is also supported for NF Services. This can be achieved when the equivalent NFs and NF Services share the same context data or by Network Function/NF Service Context Transfer procedures. Equivalent Control Plane NFs may be grouped into NF Sets, for example, several SMF/MME/AMF instances are grouped into an MME/AMF/SMF Set. NFs within an NF Set are interchangeable because they share the same context data and may be deployed in different locations, for example, different data centers on the satellite network and on the ground station, etc.

The methods, issues, or solutions disclosed in the disclosure are explained using NR access or NG-RAN Access Technology as an example and are not restricted or limited to NR access only. The disclosure is applicable for E-UTRAN access Technology, NB (Narrow Band)-S1 mode, or WB (Wide Band)-S1 mode via E-UTRAN access and/or NB-IOT (Narrowband Internet of Things) or WB-IOT (Wideband Internet of Things) Access/Architecture. The solutions which are defined for NR (5GC) are also applicable to legacy RATs like E-UTRA/LTE; the corresponding CN entities need to be replaced by LTE entities, for example, AMF with MME, g-nodeB with e-nodeB, UDM with HSS, etc. But principles of the solution remain the same. The Network used in this embodiment is explained using any 5G Core Network Function, for example, AMF. However, the network apparatus could be any of the 5G/EUTRAN Core Network Entities like AMF/SMF/MME/UPF, or the Network could be any 5G/EUTRAN RAN Entity like eNodeB (eNB) or gNodeB (gNB) or NG-RAN, etc. The messages used or indicated in this embodiment are shown as an example. The messages could be any signaling messages between the UE and the network apparatus or between different network apparatus.

The terms camp and register are used interchangeably and have the same meaning.

The terms wait timer, DisCo wait timer, Discontinuous Coverage wait timer, Random timer, Random wait timer, DCW Timer are all used interchangeably and have the same meaning. The terms wait range, Disco Wait Range, Discontinuous Coverage Wait Range, and DCW Range are all used interchangeably and have the same meaning. The term area as used in this embodiment may refer to any of cell/cell ID, TAC/TAI, PLMN, MCC/MNC, Latitude/longitude, any CAG/CAG identifier, or any geographical location/coordinate. The cause names in this embodiment are for illustration purposes, and it can have any name. The NAS messages and AS messages described in this embodiment are only for illustration purposes; it can be any NAS or AS messages as per defined protocol between UE and AMF/MME or UE and gNB (NG-RAN/any RAN node)/eNB. In this embodiment, the term Satellite is used interchangeably with 5G or 4G system with satellite access and is used to represent any Satellite(s) or constellation of Satellites(s) or any aerial body/satellite in any of the Satellite orbits (for example, LEO/MEO/GEO/IEO, etc.) or any 5G system with Satellite Access or 4G System with Satellite Access or any RAN Entity or Core Network Entity or any Network Function(s) associated with the Satellite Access/RAT/PLMN/Network.

The terms MME/AMF-Onboard and MME/AMF-lighter are used interchangeably in this embodiment and have the same meaning. The terms SAT and Satellite and satellite network are used interchangeably in this embodiment and have the same meaning.

In an embodiment, the term satellite is used, which actually represents at least one of the NF or gNB, which is onboard from a 3GPP perspective. The satellite system or satellite access, as used or defined in this embodiment, is applicable for both 5G systems with satellite access and/or 4G systems with satellite access or any RAT with satellite access. The terms satellite 3GPP access, satellite access, satellite access network, NR satellite access network, satellite NG-RAN access technology, and NR satellite access have been interchangeably used and have the same meaning. Thus, for example, when the term indicates UE sends data to the satellite, it implies that data is sent to one of the NFs or gNB (in general, a node of the 3GPP system) which is onboard the satellite. Similarly, when the satellite sends the data, one of the NFs or gNB (in general, a node of the 3GPP system) which is onboard the satellite sends the data to UE or the NF/3GPP node on the ground.

In this disclosure, MME/AMF onboard and MME/AMF on the ground are used as examples, but this same concept can be applied to any of the network functions (NFs).

The list of NFs, e.g., SMF/PCF/UDM/AUSF/MME/P-GW/S-GW/HSS/NEF/SCEF. A Control Plane NF includes one or multiple NF Services. Within an NF, an NF service may have multiple instances. These multiple NF Service instances can be grouped into an NF Service Set if they are interchangeable with each other because they share the same context data. The ground NF (e.g., MME/AMF) also can be treated as a UDSF function with whom UE context data is synchronized by all the NFs onboard the satellite.

Serving satellite: a satellite providing the satellite access to an UE. In the case of NGSO (Non-Geostationary Satellite Orbit), the serving satellite is always changing due to the nature of the constellation.

Store & Forward Satellite operation: in the context of this disclosure, it is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground station.

S&F data retention period: it is the data storage validity period for the 5G system with satellite access supporting store and forward operation (e.g. after which undelivered data stored is being discarded).

UE-Satellite-UE Communication: for the 5G system with satellite access, it refers to the communication between UEs under the coverage of one or more serving satellites, using satellite access without going through the ground station.

The concept of S&F mode is widely used in the fields of delay-tolerant networking and disruption-tolerant networking. In the 3GPP context, a service that could be assimilated to an S&F service is SMS, for which there is no need to have end-to-end connectivity between the end-points (e.g., an end-point can be a UE and the other an application server) but only between the end-points and the SMSC, which acts as an intermediate node in charge of storing and relaying. The support of S&F Satellite operation is especially suited for the delivery of delay-tolerant/non-real-time IoT satellite services with NGSO satellites.

Satellite coverage availability information can be provisioned to the UE via PDU session or SMS. Some examples of the information that comprise input to the source of satellite coverage availability information (e.g., external server) and the output it provides to the UE are defined as: a) Satellite coverage availability information can be indicated to the UE by indications corresponding to whether or not coverage is available for a specific NTN RAT Type for a particular location and time, where: These indications can be Boolean “True” (e.g. coverage available) and “False” (coverage not available); locations can correspond to grid points in a fixed array (e.g. rectangular, hexagonal); Coverage availability times may occur at fixed periodic intervals; and Coverage availability information is per RAT Type. The information provisioned to the UE can include coverage information on only one PLMN or multiple PLMNs.

If satellite coverage availability information indicates coverage is available, then additional information on whether PLMN is allowed to operate in that location can be provided to the UE. In order for the source of satellite coverage availability information to provide accurate information to the UE, the UE might indicate, for example, the following information to a source of satellite coverage availability information (e.g., an external server): a) Serving PLMN ID (if not already known or implied), b) One or more satellite RAT Types (where satellite coverage availability information is then expected for these one or more RAT Types), c) List of supported NTN frequency bands (if not implied by the particular RATs), d) Present UE location (e.g. latitude and longitude) for a reference grid point (e.g. the most southerly and then most Westerly grid point), e) Type of Array (e.g. rectangular or hexagonal), f) Minimum elevation angle.

Based on the above listed information provided by the UE, satellite coverage availability information could be delivered to the UE as a sequence of time durations for each grid point where each time duration includes an indication of coverage availability or unavailability one example of many alternatives as illustrated below for a particular grid point with N different durations

Satellite coverage availability information at a given grid point can be illustrated as <N><Binary 0 or 1><Duration 1><Binary 0 or 1><Duration 2> . . . <Binary 0 or 1><Duration N>. The grid points would be concatenated for all of the grid points to produce the satellite coverage availability information. When SMS is used to deliver the satellite coverage availability information, the UE input and satellite coverage availability information output can be delivered in a series of concatenated SMS messages using possibly the same format.

Serving satellite: A satellite providing the satellite access to a UE (e.g. providing the serving cell(s)), either for GSO or NGSO. In the case of NGSO, the serving satellite is covering a given geographic area for a limited period of time due to the nature of the orbit.

S&F Satellite operation: operation mode providing communication service (in storing and forwarding information) to a UE in periods of time and/or geographical areas in which the serving satellite is not simultaneously connected to the ground network via feeder link or ISL. For the case of UL, “store” refers to on-board storage of UL information from UE and “forward” refers to forwarding of stored UL information to the ground network. For the case of DL, “store” refers to on-board storage of DL information from the ground network and “forward” refers to forwarding of stored DL information to the UE.

Permitted CSG list: A list provided by NAS containing all the CSG identities and their associated PLMN IDs of the CSGs to which the subscriber belongs. This definition is from TS 3GPP 36.304.

Permitted CSG list: A list provided by NAS containing all the CSG identities and their associated PLMN IDs of the CSGs to which the subscriber belongs.

Allowed list: Allowed list in this embodiment can be Permitted CSG list or CSG information list or a list of unique identifiers which allow a UE to camp in a cell of a satellite, if the cell broadcasts one or one of those unique identifiers. A typical structure of the Allowed list can be a one or more unique identifiers per PLMN configured in the UE. This list can be configured in the UE by over the air procedures.

MM_Cause: In this disclosure, this may include all MM or 5GMM causes for example #12 (Tracking area not allowed), #13 (Roaming not allowed in this tracking area), #15 (No suitable cells in tracking area) or a new cause #XX etc. which lead to the UE performing a PLMN selection, cell selection, cell re-selection.

Currently, when the UE receives acceptable signal strength, e.g., acceptable/suitable cell, the UE remains camped on that particular cell to receive the services, assuming that it can receive services from that cell or network. But if there is no feeder link availability, then gNB or Network functions embedded on the satellite cannot connect to the ground and provide all the services, or only a subset of services can be provided to the UE. For example, the UE can get only Store and Forward mode of services or delay-tolerant services. Thus, if the UE remains in such an allowed cell/network, the UE may not get the required services.

The disclosure provides a network apparatus broadcasting or indicating the feeder link availability information to the UE. The UE stores the satellite coverage and feeder link availability information, e.g., expected time or location when the feeder link is available and/or not available, received from the network apparatus or application function or external server or as a part of SCAI in the UE (ME/USIM) or in any non-volatile memory or storage, and/or uses the feeder link availability information for any UE implementation or procedures.

The UEs which have delay-tolerant data to be sent in the Up Link (UL) can access and send their data to a satellite supporting the S&F functionality. The S&F functionality needs to be supported both in the UE and in the network apparatus. The UEs which do not support S&F need to be restricted from accessing 4GS or 5GS via such satellites. For example, an old UE that is sending some data via such a satellite supporting S&F might expect an acknowledgment or a response of such data within a particular time window. Failure in receiving such an acknowledgment or response might be considered as a failure to send the data/procedure being run at the UE level. Hence, such UEs should not access 4GS or 5GS via a satellite supporting S&F. Also, allowing such old UEs to access 4GS or 5GS via such satellite systems might unnecessarily overload the satellite, and legitimate UEs which support S&F might not be able to use the S&F functionality of such satellites. The UEs which support S&F need to be able to identify cells or TAs (tracking areas) satellites which can support S&F functionality. Hence, there has to be a mechanism to restrict such old version UEs from accessing such satellite systems. There should be a mechanism for UEs which support S&F functionality to be able to identify satellites which support S&F functionality. In the present disclosure, the issue can occur both in satellite access for NR (5G) and satellite access in EPC (4G). The terminology satellite and network is synonymous in this embodiment.

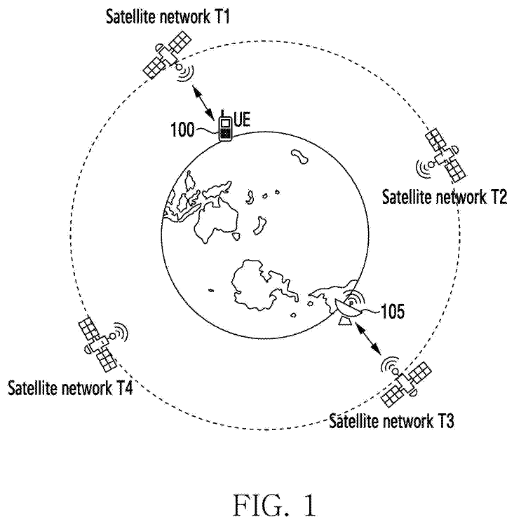

Referring now to the drawings and more particularly to FIGS. 1 through 15, where similar reference characters denote corresponding features consistently throughout the figures, these are shown various example embodiments.

FIG. 1 is a diagram illustrating S&F operation of a 5G system with satellite access where the link between the UE and the satellite network cell and between the satellite and the network apparatus are not connected at the same point in time according to the prior art. In existing terrestrial networks, all the core network entities or network functions are connected to each other. Due to this connected nature, all procedures between the UE (100) and the network apparatus (105) and between different network functions or entities can be conducted seamlessly without any significant delay. With the rise of packet-switching networks, the store and forward mode became more viable. In S&F mode, the link between the UE (100) and satellite (Service Link) and between the satellite and ground station (Feeder Link) are not connected at the same point in time. In the S&F mode, a message is first sent to a local server or gateway, and the server stores the message temporarily until it can verify that the recipient is available or until the optimal time for delivery. Once conditions are favorable(e.g. the feeder link is available), the server forwards the message to the intended recipient. FIG. 1 illustrates an area with NTN cell coverage associated with the S&F mode where the service link and the feeder links are not connected at the same point in time. The UE (100) is connected to the satellite T1, whereas the network apparatus is connected to the satellite T3.

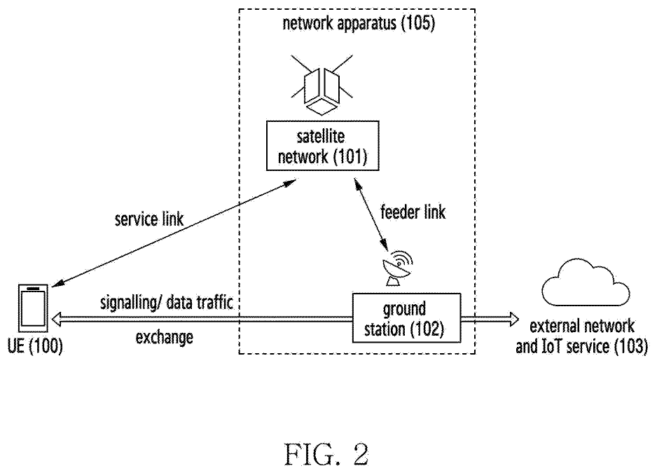

FIG. 2 is a diagram illustrating signaling/data traffic exchange between the UE (100) and the network apparatus (105) under normal/default service according to the prior art. Under normal service, the signaling and the data traffic exchange between the UE (100) and the network apparatus (105) require the service link and the feeder links to be active simultaneously so that at the time that the UE (100) interacts over the service link with the satellite network (101), there is a continuous end-to-end connectivity path between the UE (100), the satellite network (101), and the ground station (103).

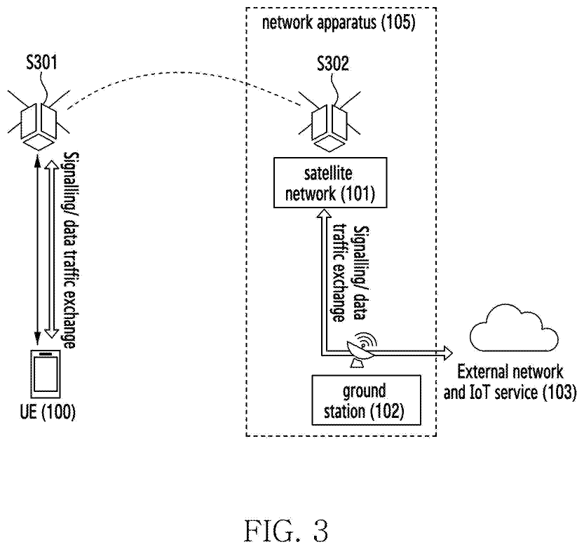

FIG. 3 is a diagram illustrating end-to-end signaling/data traffic exchange between the UE (100) and the network apparatus (105) through S&F mode according to the prior art. The S&F mode, as illustrated in FIG. 3, handles the end-to-end exchange of signaling and data traffic as a combination of two steps which are not concurrent in time. In step S301, signaling and data traffic exchange between the UE (100) and the satellite network (101) takes place without the satellite network (101) being simultaneously connected to the ground station (102) (e.g., the satellite is able to operate the service link without an active feeder link connection). Further, the connectivity between the satellite network (101) and the ground station (102) is established so that the communication between the satellite network (101) and the ground station (102) can take place. So the satellite network (101) moves from being connected to the UE (100) as illustrated in step S301 to being connected to the ground station (102) as illustrated in step S302.

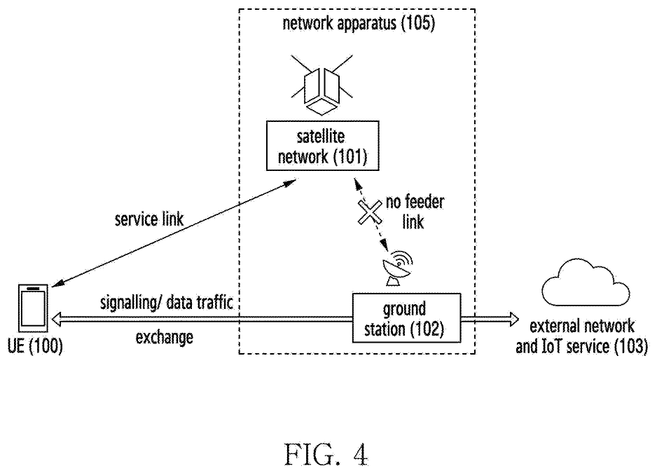

FIG. 4 is a diagram illustrating hollow networks where the network apparatus (105) does not support S&F mode and there is no feeder link available between the satellite network (101) and the ground station (102) according to the prior art. Given the service link between the UE (100) and the satellite network (101), the UE (100) assumes that it can obtain the services from the network apparatus (105) without determining the hollow network, which is a network apparatus that does not support S&F operation mode and the network apparatus that is not associated with the feeder link, i.e., the network apparatus which can neither provide normal service nor the service in S&F mode.

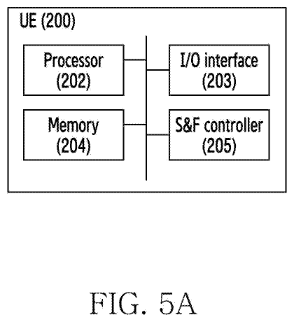

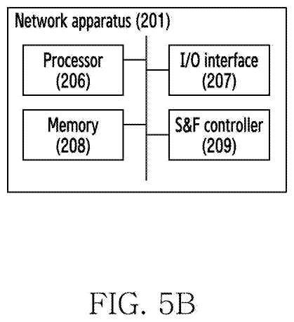

FIG. 5A is a block diagram illustrating an example configuration of the UE according to various embodiments. With reference to FIG. 5A, the UE (200) can encompass a diverse range of devices including but not limited to laptops, palmtops, desktops, mobile phones, smartphones, Personal Digital Assistants (PDAs), tablets, wearable devices, Internet of Things (IoT) devices, virtual reality devices, foldable devices, flexible devices, display devices, immersive systems, etc. In an embodiment, the UE (200) includes a memory (204), a processor (e.g., including processing circuitry) (202), an I/O interface (e.g., including circuitry) (203), an S&F controller (e.g., including circuitry) (205).

The memory (204) stores instructions to be executed by the processor (202). The memory (204) can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (204) may in some examples be considered a non-transitory storage medium. The non-transitory storage medium is not embodied in a carrier wave or a propagated signal. However, the term non-transitory should not be interpreted that the memory (204) is non-movable. In some examples, the memory (204) stores larger amounts of information. In certain examples, a non-transitory storage medium may store data that can over time change (e.g., in Random Access Memory (RAM) or cache). The memory (204) stores the artificial intelligence/machine learning (AI/M1L) capability of the UE (200), training data of the AI/ML models, and the values of the Key Performance Indicators (KPIs). Further, it stores capabilities of the UE (200) and the information regarding the occurrence of the events.

The processor (202) may include various processing circuitry, including, for example, one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (202) may include multiple cores and is configured to execute the instructions stored in the memory (204). The processor (202) fetches the AI/ML capability of the UE (200), information regarding the KPIs, and the occurrence of critical UE events. Further, the processor (202) retrieves instructions and executes them. Thus, the processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The I/O interface (203) may include various circuitry and transmits the information between the memory (204) and external peripheral devices. The peripheral devices are the input-output devices associated with the network apparatus (201). The I/O interface (203) receives several pieces of information from a plurality of UEs, network devices, servers, and the like. The I/O interface (203) ensures that the operating speed of the processor is synchronized with respect to the input and output devices. The I/O interface (203) establishes a connection between different peripheral devices like system performance monitor, AI/MVL classification model, memory, and others to perform the AI/ML model management for any scenario-specific action like deactivate or switch or fallback or any other functions of the AI/ML model to enhance the user experience.

In an embodiment, the S&F controller (205) of the UE (200) may include various circuitry and communicates with the processor (202), I/O interface (203), and memory (204) for managing PLMN selection, cell selection, or reselection for S&F modes in a wireless network system. The S&F controller (205) is configured to determine that a first cell supports the S&F mode and a feeder link is unavailable. Further, the S&F controller (205) performs a PLMN selection, a cell selection, or a cell reselection in the wireless network system to search for a second cell wherein the feeder link is available on the second cell and a network apparatus associated with the UE (200) is able to provide normal services to the UE (200).

The term first cell, second cell is used in the disclosure but this can also be treated as selection of TAI or the PLMN. For e.g. if UE selects a cell then e.g. at least part of one TAI this implies UE has selected that TAI or when UE selects a cell, than that cell is part of the PLMN thus its as good as selecting a PLMN.

In an embodiment, the S&F controller (205) determines whether the second cell is available and further the S&F controller (205) camps and registers on the second cell in response to determining that the second cell is available. This process ensures that the UE (200) can maintain connectivity and service continuity by switching to a cell that can support the required feeder link, thereby enhancing the user experience by minimizing/reducing service interruptions. The S&F controller (205) is also responsible for continuously monitoring the status of the second cell to ensure its availability and readiness to provide the necessary services.

In an embodiment, the S&F controller (205) determines whether the second cell is unavailable and camps and attaches to the first cell in response to determining that the second cell is unavailable. Further, the S&F controller (205) determines whether a timer T expires when the UE (200) is registered for normal services on a second cell and initiates a search for a higher priority PLMN upon expiration of the timer T. If a higher priority PLMN is found, the S&F controller (205) evaluates whether the associated cell is the first cell and, if so, ignores or skips this cell, its tracking area identifier (TAI), or its PLMN.

The S&F controller (205) continues to search for any other higher priority PLMN available in the wireless network system for selection that is not the first cell or continues to get services on the current second cell in the absence of any other higher priority PLMN that is not the first cell and can provide normal services.

In an embodiment, the S&F controller (205) determines whether a timer T expires when the UE is on the first cell and initiates a search for a higher priority PLMN that can provide S&F services to the UE (200) or at least one of the higher priority PLMN and lower priority PLMN that can provide normal services to the UE (200). This mechanism ensures that the UE (200) is always connected to the most optimal network cell, thereby enhancing the reliability and efficiency of the wireless network system. Additionally, the S&F controller (205) is configured to perform the search for at least one of the higher or lower priority cells/TAI/PLMN capable of providing normal services to the UE (200) even when the UE (200) is registered on a higher priority cell, ensuring seamless service continuity.

In an embodiment, the S&F controller (205) determines the availability of the feeder link. When the network apparatus broadcasts support for S&F mode, the S&F controller (205) determines that the feeder link is unavailable, whereas when the network apparatus does not broadcast support for S&F mode, the S&F controller (205) determines that the feeder link is available. This capability allows the S&F controller (205) to dynamically adapt to network conditions and make informed decisions about cell selection and reselection, thereby optimizing the overall performance and reliability of the wireless network system.

The S&F controller (205) may refer, for example, to an innovative hardware component integrated into the UE (200) via processing circuitry, which includes logic gates, integrated circuits, microprocessors, microcontrollers, memory circuits, and various electronic and optical components. These circuits may be on semiconductor chips or substrates like printed circuit boards.

At least one component of the S&F controller (205) may use an AI/ML model.

Functions associated with the AI model are executed through the memory (204) and processor (202). The processors manage input data processing based on predefined operating rules or AI/ML models stored in volatile and non-volatile memory. These models are created through training or learning processes.

Learning involves applying a learning process to multiple data sets to develop a desired operating rule or AI/ML model. This can occur within the device or via a separate server/system. The AI/IL model may include multiple neural network layers, each with weight values and layer operations. Examples of neural networks include CNN, DNN, RNN, RBM, DBN, BRDNN, GAN, and deep Q-networks.

The learning process trains a target device (e.g., a robot) using various data to enable it to make decisions or predictions. Learning methods include supervised, unsupervised, semi-supervised, and reinforcement learning.

FIG. 5B is a block diagram illustrating an example configuration of the network apparatus according to various embodiments. The network apparatus (201) for managing PLMN selection, cell selection, or reselection for S&F modes in a wireless network system includes a memory (208) comprising information about the availability of a feeder link and the ability to perform S&F mode, a processor (e.g., including processing circuitry) (206), an I/O interface (e.g., including circuitry (207) and an S&F controller (e.g., including circuitry) (209) coupled to the memory and the processor. The S&F controller (209) is configured to determine whether a feeder link is available and whether the network apparatus (201) supports the S&F mode. It then broadcasts a signal message to the UE (200) indicating that the network apparatus (201) is operating in the S&F mode when the feeder link is unavailable and the network apparatus (201) supports the S&F mode. Alternatively, it switches off the network apparatus (201) and stops the broadcast of the signal message from the network apparatus when it determines that the feeder link is unavailable and the network apparatus (201) does not support the S&F mode.

In an embodiment, the network apparatus (201) broadcasts the signal message indicating support of the S&F mode as part of a System Information Block (SIB). This ensures that the UE (200) receives the necessary information regarding the operational status of the network apparatus (201) and its ability to support S&F mode. The inclusion of this information in the SIB allows for efficient communication and seamless transition for the UE (200) between different network states, thereby enhancing the overall user experience and maintaining network reliability.

The memory (208) within the network apparatus (201) may be used for storing the information required for determining the availability of the feeder link and the capability to perform S&F mode. This stored information is vital for the processor (206) and the S&F controller (209) to make real-time decisions regarding the network's operational status. The processor (206) processes the data from the memory (208) and coordinate with the S&F controller (209) to manage the broadcasting of signal messages. This solution ensures that the network apparatus (201) can dynamically adapt to changing network conditions, thereby optimizing performance and maintaining connectivity for the UE (200). The description of the processor 202 of FIG. 5B applies equally here to the processor 206.

Additionally, the S&F controller (209) may include circuitry and may be designed to handle various scenarios where the feeder link may become unavailable. By broadcasting the signal message indicating the S&F mode, the network apparatus (201) informs the UE (200) of the current network conditions, allowing the UE (200) to make informed decisions regarding cell selection or reselection. This proactive communication helps in reducing potential disruptions in service and provides a more resilient network environment. Overall, the disclosure illustrates the importance of the coordinated operation between the memory (208), processor (206), and S&F controller (209) in managing the network apparatus (201) for optimal performance in S&F modes.

While FIGS. 5A and 5B illustrate the hardware components of the UE (200) and the network apparatus (201) respectively, various embodiments may include different or additional components. The labels or names of these elements are illustrative and do not limit scope of the disclosure. Components may also be combined to perform similar functions.

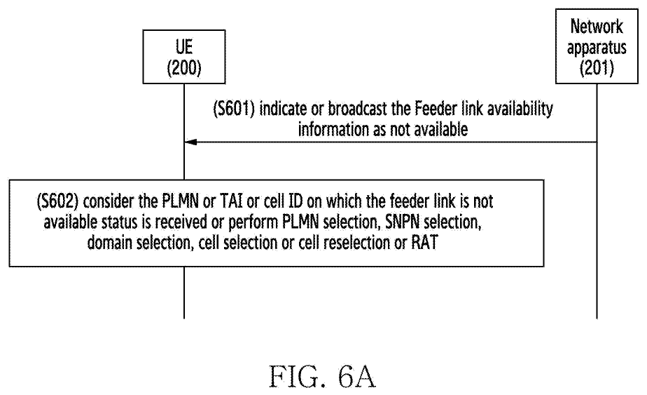

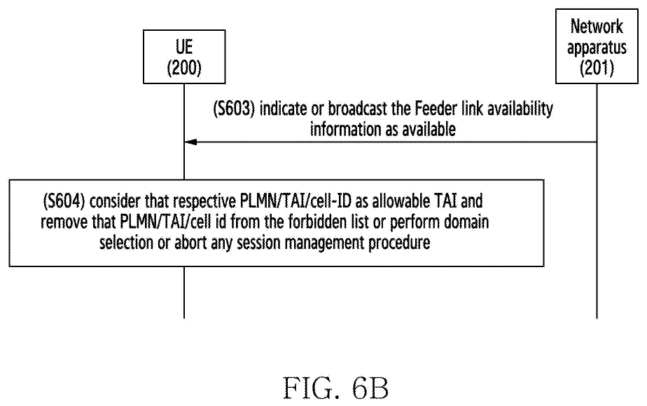

FIG. 6A is a signal flow diagram illustrating an example scenario of a network apparatus indicating feeder link availability information according to various embodiments. The network apparatus (201) indicates or broadcasts the unavailability of the feeder link to the UE (200)(i.e. support of S&F feature or S&F mode) as illustrated in step S601. The network apparatus (201) configures or pre-configures in any Access Stratum (AS) or Non-Access Stratum (NAS) message (for example, Attach Accept, registration accept, RRC reconfiguration, UE configuration update, NAS modification message, or any AS or NAS message) or any Application function or using data path or as a part of Service Communication Architecture Interface (SCAI) or using PDU session procedure or using SMS or in the broadcast signal and others to the UE (200). The AS messages facilitate communication related to the physical layer and radio access, dealing with radio resource management and connection establishment, whereas the NAS messages handle higher-layer signaling that is independent of the radio interface. The NAS messages are used in mobility management and session management. The SCAI refers to interfaces used in Satellite coverage availability information, allowing for interactions between various network components, including core and application functions.

The network apparatus (201) may follow any of the below procedure(s) or mechanism(s) in any order or combination(s). A 5G/4G system/network with Satellite access may indicate or broadcast the feeder link availability information (e.g., expected time or location when the feeder link is available and/or not available) to the UE in any broadcast message such as MIB, SIB, or any other broadcast message. In an embodiment, the 5G/4G system/network with Satellite access may configure the UE (200) with the feeder link availability information in any AS or NAS signaling messages such as RRC Reconfiguration, Attach Accept, Registration Accept, UE configuration update, NAS modification procedure, or any of the AS or NAS messages or using data path (for example, PDU session procedure or SMS or any other method). In an embodiment, the 5G/4G system/network with Satellite access may configure or preconfigure the UE (200) with the feeder link availability information (for example, (pre)configure in the SIM Card or eSIM or USIM or in the device/ME). In an embodiment, the 5G/4G system/network with Satellite access may configure the UE (200) with the feeder link availability information (e.g., expected time or location when the feeder link is available and/or not available) by any application function or any application or by an external server or by any OAM mechanism (Operations And Management operations) optionally based on operator policy.

A 5G/4G system/network with Satellite access or the application function may configure the UE (200) with or indicate/broadcast/configure the feeder link availability information as part of SCAI. In an embodiment, the entity (for example, external server) or network function, whichever configures or broadcasts the SCAI, may include feeder link availability as part of the SCAI. The feeder link availability information may be based on per location/area and/or per satellite and/or per time slot and/or per PLMN and/or per geographical area and/or per time zone and/or per operator policy and/or per type/priority of UE (200) and/or per type/priority of data and/or per type/priority of application or based on network/area/Satellite identifiers/parameters. Feeder link availability information may have the time or location or a combination of time and location when the feeder link becomes available and/or the time and/or location or a combination of time and location when the feeder link becomes unavailable or both the combination of feeder link available and not available status (including the range of the availability status). In an embodiment, the feeder link availability information may have the time or location when the feeder link becomes available. In an embodiment, the feeder link availability information may have the time or location when the feeder link becomes unavailable.

As in response to the broadcast of the feeder link availability information to the UE (200) by the network apparatus (201), the UE (200) may follow any of the following procedure(s) or mechanism(s) in any order or combination(s). The UE (200) shall store the Satellite coverage and feeder link availability information (e.g., expected time or location when the feeder link is available and/or not available) received from the network apparatus (201) and/or satellite or application function or external server or as a part of SCAI in the UE (200) (ME/USIM) or in any non-volatile memory or storage and/or use this information for any UE (200) implementation or procedures.

With the Satellite coverage and feeder link availability information, the UE (200) can take below decision (in any order or combinations):

a) When the UE (200) determines Feeder link is not available: The UE (200) can stay in S/F mode (for ex- if the UE (200) supports S&F mode, the UE (200) can opt for S/F mode, optionally for this 5G/4G system with satellite access):

Both the UE (200) and 5G/4G system with satellite access supports S/F mode, UE (200) shall send data in S/F mode to the satellite.

If at least one of the UE (200) and/or 5G/4G system with satellite access does not support S/F mode, the UE (200) may decide not to camp/register on this 5G/4G system with satellite access(e.g. the UE may not select this cell or bar/forbid the cell for selection/reselection/handover) and optionally the UE (200) may not opt to enter S/F mode for this Network/Satellite system.

If at least one of the UE (200) and/or 5G/4G system with satellite access does not support S/F mode, the UE (200) does not send the data or NAS signalling message or any signalling exchange with the network apparatus while feeder link is not available and/or shall wait for the feeder link availability to send the data or NAS signalling message or any signalling exchange, optionally for this 5G/4G system with satellite access.

The UE (200) apply power savings by entering in power saving mode and apply any of the power saving parameters e.g. Extended Discontinuous Reception (eDRX) or Minimum Information for Communication (MICO) mode and will not be in S/F mode.

The UE (200) may act as it is in satellite discontinuous coverage. For e.g. the UE (200) may assume it to be in NO service, i.e. (DE) REGISTERED.NO CELL AVAILABLE state.

The UE (200) may optionally apply any/all of the above procedures or methods based on per location/area or/and per satellite or/and per time slot or/and per PLMN or/and per geographical area or/and per time zone or/and per operator policy or/and per type/priority of the UE (200) or/and per type/priority of data or/and per type/priority of application or based on network/area/Satellite identifiers/parameters or only for the 5G/4G system with satellite access for which this feeder link availability information is valid.

b) If the UE (200) determines feeder link is available: The UE (200) may send the data or NAS signalling or any signalling message to network apparatus. The UE (200) and/or network apparatus (201) may negotiate the data retention period and/or the ack validity timer based on the feeder link availability time (e.g. Expected time or location when feeder link is available). (For example: If the feeder link availability time is X for the network apparatus (201) without feeder link and operating in S/F mode, the UE (200) and/or network apparatus (201) may negotiate the data retention period as X+Y and/or ack validity timer as X+Y+Z).

In an embodiment, the power saving parameters are shown with MICO mode and/or active timer as an example. The solutions are applicable to any of the Power Saving Modes (PSM) for any of the Radio Access Technologies (RAT)(s) low-power contexts by enabling devices to communicate minimal necessary information. The power saving modes like eDRX, MICO approach, and others help optimize energy consumption and improve overall network efficiency across various wireless network systems. The solution is applicable to any of the power saving mechanisms/timers/parameters but not restricted or limited to only as: Active Time, Periodic TAU Timer/Periodic Update Timer, Periodic Registration Timer, and eDRX parameters (such as cycle length)

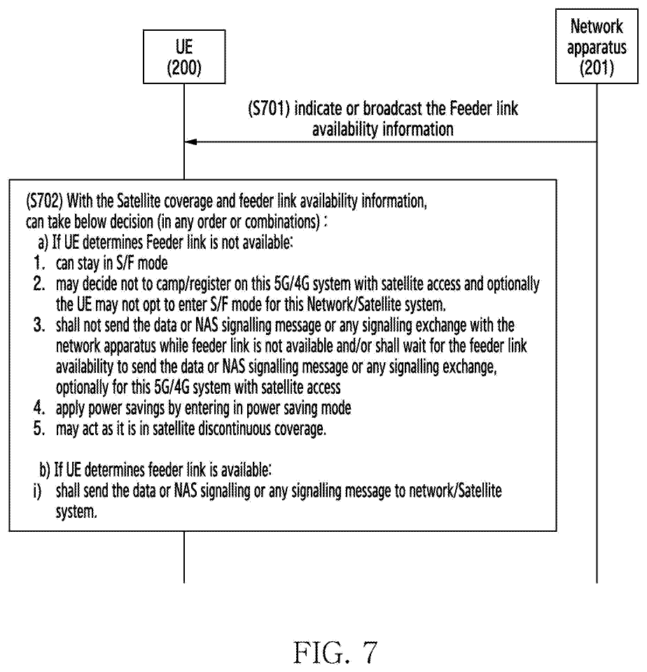

FIG. 7 is a sequence diagram that illustrates the scenario of non-availability of the feeder link at the UE (200), according to various embodiments. The network apparatus (201) indicates the UE (200) that the feeder link is available. The UE (200) determines feeder link is not available as described in this embodiment or by any other methods, or the status of feeder link in the selected satellite (network elements on board the satellite) switches from available to not available, then the UE (200) performs at least one of the below actions in any order or combination:

The UE (200) consider the PLMN or TAI or cell ID on which the feeder link is not available status is received the UE (200) can consider that respective PLMN/TAI/cell-ID as forbidden PLMN/TAI/cell-ID and search for some other PLMN/TAI/cell ID for e.g. on which feeder link is available:

PLMN Selection: The UE (200) may decide to perform PLMN selection to select another PLMN which has feeder link available and can provide services to the UE (200). The UE (200) may attempt to find another PLMN for e.g. for which the feeder link is available(i.e. normal services can be provided).

SNPN selection: The UE (200) operating in SNPN access operation mode over 3GPP access may perform SNPN selection procedure to select a SNPN which has feeder link available and can provide services to the UE (200).

Domain selection: The UE (200) may choose to change the UE's domain settings such as UE Usage setting, Voice Domain Preference (VDP), UE mode of operation etc. to camp/register. In general the UE (200) may perform domain selection to select the domain which can provide services to the UE (200).

Cell selection/reselection: The UE (200) may perform/restart cell selection/reselection procedure to select another gNB/satellite with same or different PLMN and RAT which has feeder link availability and which can provide services to the UE (200).

RAT selection: The UE (200) may perform cell selection/reselection or PLMN selection procedure to select a new RAT. The UE (200) performs RAT selection to determine the suitable RAT to use for connecting to the wireless network.

FIG. 6B is a signal flow diagram illustrating an example scenario of network apparatus indicating the UE of the availability of the feeder link, according to various embodiments. The network apparatus indicates or broadcasts the UE (200) that the feeder link is available as illustrated in step S603.

The UE (200) determines feeder link is available, or the status of feeder link in the selected satellite switches from not available to available, then the UE (200) consider that respective PLMN/TAI/cell-ID as allowable TAI and remove that PLMN/TAI/cell id from the forbidden/barred list or perform domain selection or abort any session management procedure as depicted in step S604. The UE (200) performs at least one of the below actions in any order or combination:

The PLMN or TAI or cell ID on which the feeder link is available status is received as available, the UE considers that respective PLMN/TAI/cell-ID as allowable TAI and remove that PLMN/TAI/cell id from the forbidden list optionally, if UE (200) had added that respective PLMN/TAI/Cell ID to forbidden list due to feeder link unavailability.

Domain selection: The UE (200) may choose to change UEs domain settings such as UE Usage setting, Voice Domain Preference (VDP), UE mode of operation etc. to camp/register with the satellite and get normal services.

The UE (200) may abort any cell selection, cell reselection, and PLMN selection, SNPN selection procedure when the selected cell has feeder link available or the status changes from Feeder link not available to feeder link available. The UE (200) may attempt to camp/register/attach/get service from the selected cell.

In an embodiment, out of service/recovery from out of coverage/switch on or recovery from lack of coverage case, the UE (200) during recovery from out of service or during switch on may decide to camp/attach/register with cells/satellite only which have feeder link available. The UE (200) may decide the found cell as not suitable cells or un-selectable when the feeder link is unavailable/not available and ignore/deprioritize such found cells. The UE (200) will continue to search for other PLMN or other cell/satellite within the same PLMN which has feeder link available. The UE (200) may change its domain settings such as the UE (200) usage setting, voice domain preference (VDP), UE mode of operation, etc., to camp/register with the satellite. The UE (200) may store the expected time of feeder link availability of the found satellites to select the satellite if during scanning no other satellite with feeder link availability is found.

In an embodiment, the UE (200) may store the feeder link availability information of all found cells which may have feeder link available or not available and use this information at the time of PLMN selection/SNPN selection/cell selection/cell reselection. At a later point of time, when feeder link is available to any of the found satellites and the UE (200) is performing PLMN/SNPN/cell selection or cell reselection, UE may choose that particular satellite/cell. The UE (200), if it supports S/F mode, may operate in S/F (store and forward) mode or it may choose to act as per this embodiment. The UE (200), if it does not support S/F mode, may perform any of the procedures mentioned in this embodiment to search/select a PLMN/cell which has feeder link availability and provide services to the UE (200). In the case of higher priority PLMN selection, UE (200) will ignore the PLMN/cell if it does not support feeder link or deprioritize the respective PLMN/cell.

When the UE (200) is camped/attached on a VPLMN and is performing Higher Priority PLMN Scan, if the UE (200) finds/searches any higher priority PLMN with the cell/satellite which has feeder link unavailable, it will not select the Higher Priority PLMN cell or ignore the found cell or deprioritize the found cell/PLMN/TAI. The UE (200) may optionally start a timer (e.g., timer t) after which UE (200) may again check the feeder link availability of the Higher Priority PLMN cell.

When the UE (200) is camped/attached on a VPLMN and is performing Higher Priority PLMN Scan, if the UE (200) finds any higher priority PLMN with the cell/satellite which has feeder link available, UE (200) will register/attach or reselect to the found cell/PLMN.

In an embodiment, the UE (200) will use the feeder link availability information of the Higher Priority PLMN found cell and delay the camping/registration to the Higher Priority PLMN found summary. When the timer T (Higher priority PLMN search timer) expires or when UE switches ON or recovers from lack of coverage, the UE (200) ignores/deprioritizes/postpones the selection of the PLMN/TAI/Cell which indicates to UE (or UE determines based on the methods discussed in this embodiment or based on other methods) that the feeder link is not available, and the UE selects any other higher priority PLMN for which the feeder link is available. Otherwise, UE may remain camped on the current selected PLMN VPLMN or HPLMN Cell till the time feeder link becomes available.

An example for the UE (200) at switch on or recovery from lack of coverage: Satellite cells s1, s2, and s3 available in an area al at the time t1. Satellite cell s1 and s2 belong to PLMN p1, whereas satellite cell s3 belongs to PLMN p2. The UE (200) belonging to PLMN p1 is switched on at time t1 in area al, or UE (200) which was out of service reaches area al at time t1. The UE (200) searches for services using satellite access and finds satellite cell s1. On reading the broadcast from gNB/cell/satellite cell s1 (or by any other NAS/AS signaling or configuration), the UE (200) determines that there is no feeder link available with the satellite cell s1. The UE (200) performs cell selection procedure and finds satellite cell s2. On reading the broadcast from gNB/cell/satellite cell (or by any other NAS/AS signaling or configuration), UE determines that feeder link is available with satellite cell s2. UE (200) camps/selects/registers/attaches with the satellite s2.

In another example, there is no feeder link available with satellite cell s2. The UE (200) does not find any other satellite(also called as NTN cell) or non satellite(also called as TN) cell belonging to PLMN p1 during cell search. The UE (200) then performs PLMN selection procedure and selects PLMN p2. The UE (200) finds the satellite cell s3 belonging to PLMN p2 having feeder link available. The UE (200) camps/selects/registers/attaches with the satellite cell s3, and satellite cell s3 provides normal service to UE (200).

In another example, satellite cell s3 also does not have feeder link available with it. The UE (200) in such case, when it finds no suitable satellite with feeder link available, changes its domain preference to get services from satellite cell s1. E.g., changes from voice centric to data centric, etc.

Higher priority PLMN search case example: Satellite cells s1 and s2 are available in an area a1, at the time t1. Satellite cell s1 belongs to PLMN p1, whereas satellite cell s2 belongs to PLMN p2. The UE belonging to PLMN p2 is getting services from satellite cell s1 at time t1 in area a1, i.e. UE is in roaming. Satellite cell s1 has feeder link available. When UE moves to idle state, it searched for higher priority PLMN i.e. PLMN p2 using higher priority PLMN search procedure. The UE finds satellite cell s2 belonging to PLMN p2 while performing higher priority PLMN search procedure. The UE, on reading broadcast (or by any other NAS/AS signalling or configuration) determines that satellite cell s2 does not have feeder link available. UE deprioritizes/ignores/postpones reselection/camping/attaching/registering to satellite cell s2 of PLMN p2 because it does not have feeder link and stays with satellite cell s1 of PLMN p1, which has feeder link available even when it is not the priority PLMN for the UE (200).

UE At switch on or recovery from lack of coverage example: Satellites cell (gNB or any other CN function on-board the satellite) broadcasting in area al at the time t1 belonging to PLMN p1, are broadcasting cell id as p1s1 and p1s2. Whereas Satellite cells (gNB on-board the satellite) belonging to PLMN p2 are broadcasting cell id as p2s1 and p2s2. PLMN P1 does not have feeder link available. PLMN p2 has feeder link available at the same time. Optionally, the UE (200) belonging to PLMN p1 does not support S/F operation mode, and is searching for satellite which can serve it and has feeder link availability. The UE (200) finds the cell p1s1, on reading the broadcast (or by any other NAS/AS signalling or configuration), it determines that the feeder link is not available with cell p1s1. In general UE determines that cell p1s1, is not connected via feeder link to the ground station. I.e. feeder link is not available. UE (200) performs any of the cell selection/cell reselection/PLMN selection/SNPN selection procedure to find a suitable cell with feeder link availability. In general UE deprioritizes or ignores the cells/TAI/area/CAG/PLMN which indicate to the UE that feeder link is not available and UE selects/searches for next higher priority PLMN/cell/TAI/area/CAG. On performing cell selection/cell reselection/PLMN selection/SNPN selection procedure, UE finds cell p2s1 and has feeder link availability. Then that next higher priority PLMN/cell/TAI/area/CAG/CSG cell is selected by the UE (200). The UE (200) attaches/registers/camps on the cell p2s1 to get services using satellite access. The UE (200) belonging to PLMN p1 supporting S/F mode may stay with p1s1 if the satellite cell p1s1 does not have feeder link availability.

Higher priority PLMN search case example: Satellite cell (gNB or eNB or any other CN function on-board the satellite) broadcasting in area al at the time t1 belonging to PLMN p1, is broadcasting cell id as p1s1. Whereas Satellite cell (gNB on-board the satellite) belonging to PLMN p2 are broadcasting cell id as p2s1. The UE belonging to PLMN p2 is getting services from satellite cell p1s1 at time t1 in area a1, e.g. UE is in roaming. Satellite cell p1s1 has feeder link available whereas satellite cell p2s1 does not have feeder link available and is operating in S/F operation mode. When the UE moves to idle state, it searches for higher priority PLMN e.g. PLMN p2 using higher priority PLMN search procedure. The UE finds satellite cell s1 belonging to PLMN p2 while performing higher priority PLMN search procedure. On reading broadcast or by any other NAS/AS signalling message or configuration or based on any other methods discussed in this embodiment determines that satellite cell p2s1 does not have feeder link available. UE delays/deprioritizes/ignores/postpones reselection/camping/attaching/registering to satellite cell p2s1 of PLMN p2 because it does not have feeder link and stays with satellite cell p1s1 of PLMN p1, which has feeder link available even when it is not the priority PLMN for the UE i.e. PLMN p1 is lower priority PLMN for UE (200). In general UE (200) deprioritizes or ignores the cells/TAI/area/CAG/PLMN which indicate to the UE (200) that feeder link is not available and UE selects/searches for next higher priority PLMN/cell/TAI/area/CAG. If no other higher priority PLMN is found with feeder link availability then UE (200) stays with current cell/PLMN.

If the satellite cell p2s1 has feeder link available, i.e., it is providing normal services (not in S/F operation mode), the UE (200) selects/reselects to higher priority PLMN cell, i.e., satellite cell p2s1, and attempts TAU/mobility registration update or registration/attach request to the cell p2s1.

In summary, the UE (200) will select the highest priority PLMN/cell/TAI supporting only S/F operation mode as a last resort, i.e., if no other PLMN/cell/TAI is available in the area which can provide it normal services (not only the S/F operation mode related services).

In an embodiment, the UE (200) selects a PLMN based on whether the feeder link is available, i.e., if the feeder link is available, then the UE (200) selects the cell of that respective PLMN; otherwise, it would skip and search for the next higher priority PLMN available and allowable (optionally) in that area.

In an embodiment, after deducing the feeder link is not available, the UE (200) performs PLMN selection, cell selection, and cell reselection procedures.

In an embodiment, when the feeder link is not available, it implies that the network apparatus is operating in the store and forward operation mode.

In an embodiment, if the feeder link is not available and if the network apparatus (201) does not support store and forward operation mode, then the network apparatus (201) should stop broadcasting any signal in that area and not allow any type of RACH features. The network apparatus (201) should behave as if it is not giving any service in that area. From the UE (200) perspective, it will be in a no service area from that PLMN perspective.

In the disclosure, the term satellite cell is used but the disclosure can be used/applied even for the terrestrial network(TN) cell e.g. non satellite cell(s).

FIG. 7 is a signal flow diagram illustrating an example scenario of the network apparatus indicating the feeder link availability information to the UE according to various embodiments. The network apparatus (201) indicates or broadcasts the feeder link availability information as illustrated in step S701. The network apparatus (201) may configure or pre-configure in any AS or NAS message (for example, Attach Accept, registration accept, RRC reconfiguration, UE configuration update, NAS modification message, or any AS or NAS message) or any Application function or using data path or as a part of SCAI or using PDU session procedure or using SMS and others to the UE (200). With the Satellite coverage and feeder link availability information, UE (200) stores the feeder link availability information and can take the below decision (in any order or combinations):

In step S702, if the UE (200) determines Feeder link is not available:
UE can stay in S/F mode (for ex- if UE supports store and forward mechanism, UE can opt for S/F mode, optionally for this 5G/4G system with satellite access). When both the UE (200) and 5G/4G system with satellite access supports S/F mode, the UE (200) shall send data in S/F mode to the satellite.
If at least one of the UE (200) and/or 5G/4G system with satellite access does not support S/F mode, the UE (200) may decide not to camp/register on this 5G/4G system with satellite access and optionally the UE (200) may not opt to enter S/F mode for this Network/Satellite system.
If at least one of the UE (200) and/or 5G/4G system with satellite access does not support S/F mode, the UE (200) shall not send the data or NAS signalling message or any signalling exchange with the network while feeder link is not available and/or shall wait for the feeder link availability to send the data or NAS signalling message or any signalling exchange, optionally for this 5G/4G system with satellite access
The UE (200) apply power savings by entering in power saving mode e.g. edrx or MICO mode and will not be in S/F mode:
The UE (200) may act as it is in satellite discontinuous coverage. For e.g. UE may assume it to be in NO service, i.e. (DE)REGISTERED.NO CELL AVAILABLE state.
The UE may optionally apply any/all of the above procedures or methods based on per location/area or/and per satellite or/and per time slot or/and per PLMN or/and per geographical area or/and per time zone or/and per operator policy or/and per type/priority of UE or/and per type/priority of data or/and per type/priority of application or based on network/area/Satellite identifiers/parameters or only for the 5G/4G system with satellite access for which this feeder link availability information is valid.

If the UE (200) determines feeder link is available: UE shall send the data or NAS signalling or any signalling message to network/Satellite system.

The UE (200) and/or network apparatus (201) may negotiate the data retention period and/or the Ack validity timer based on the feeder link availability time (i.e., expected time or location when the feeder link is available). For example, if the feeder link availability time is X for the 5G/4G system/network with satellite access without a feeder link and operating in S/F mode, the UE (200) and/or network may negotiate the data retention period as X+Y and/or Ack validity timer as X+Y+Z.

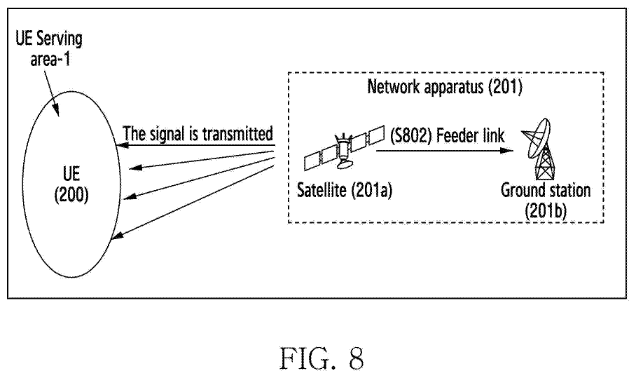

FIG. 8 is a diagram illustrating a UE connected to the cell having the feeder link according to various embodiments. The figure illustrates the satellite network (201a) which is directly connected to the ground station (201b) through the feeder link as represented by S802. The figure illustrates the arrows emanating from the network apparatus (201) to illustrate the distribution of services to the UE (200) located in the serving area-1. The illustration conveys the interconnectedness of the satellite network (201a) and the ground station (201b) and the feeder links, highlighting the role of the satellite network (201a) in providing communication capabilities through the feeder link and ground station (201b) to connect with the UE (200).

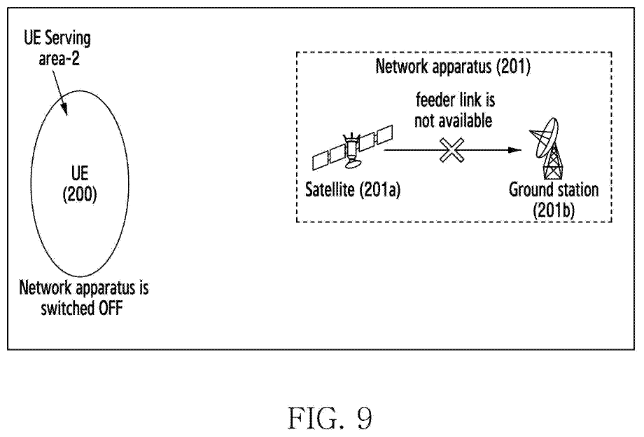

FIG. 9 is a diagram illustrating a UE connected to the cell without a feeder link and to the network apparatus that does not support S&F operation mode according to various embodiments. When the UE (200) is connected to the network apparatus (201) which does not support services in S&F mode and in addition when the feeder link is also unavailable, the network apparatus (201) gets switched OFF and does not broadcast any signal to the UE (200).

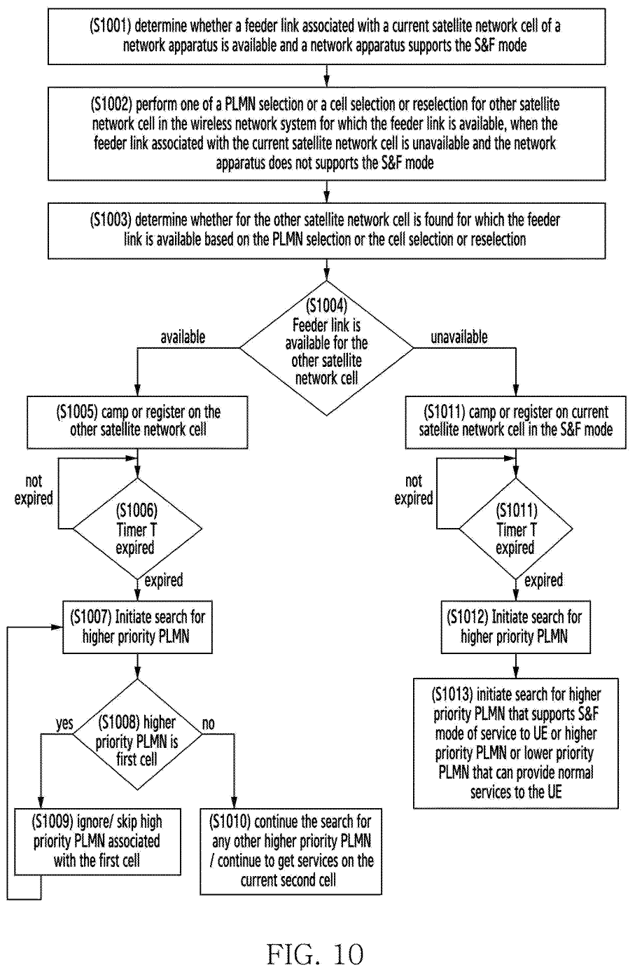

FIG. 10 is a flowchart illustrating an example method for managing the PLMN selection, cell selection, or reselection for S&F mode in a wireless network system according to various embodiments. The PLMN selection, cell selection, and cell reselection are processes in a wireless network system that ensure that the UE (200) maintains optimal connectivity and service quality as they move through different coverage areas. The PLMN selection or cell selection allows the UE (200) to identify and connect to the most suitable cell upon powering on or when transitioning from an idle state based on factors like whether the cell can provide the normal service or has a feeder link or can provide the service in S&F mode. The cell reselection enables the UE (200) with active sessions to switch to a better cell which can provide the normal service or service in S&F mode or which is a high priority PLMN or a low priority PLMN which can provide the normal services. The PLMN selection, cell selection, and cell reselection enable the UE (200) to choose the suitable cell which is available, ensuring that the UE (200) connects to the cell which can provide desired services, enhancing the user experience and ensuring seamless connectivity.

At step S1001, the UE (200) determines that the first cell (current cell) supports the services in S&F mode but cannot provide normal services as the feeder link is unavailable. Further, the UE (200) performs the PLMN selection, the cell selection, or the cell reselection in the wireless network system to search for a second cell wherein the feeder link is available on the second cell and the network apparatus (201) associated with the UE (200) is able to provide normal services to the UE (200) as illustrated at step S1002. At step S1003, the UE (200) determines whether the second cell (another cell) is available that can provide normal service. On determining the second cell, the UE (200) camps and registers on the second cell that can provide normal services. Further, if the second cell is not available, the UE (200) continues to register on the first cell.

Timers are used in the UE (200) to regulate the session and connection management for power saving, network registration, and others. The Timer T in the UE (200) regulates how long the UE (200) waits to perform search/scan for HPLMN/EHPLMN or before scanning for higher priority PLMN. When the UE (200) is registered to the second cell that provides normal services, the Timer T in the UE (200) is continuously monitored by the UE (200) as illustrated at step S1006. When the UE (200) determines the expiration of the Timer T, the UE (200) initiates the search for a higher priority PLMN as illustrated at step S1007. At step S1008, the UE (200) checks whether the available high priority PLMN is the first cell. On determining that the available high priority PLMN is the first cell, the UE (200) ignores and skips registering on the first cell associated with the higher priority PLMN, a tracking area identifier (TAI) associated with the first cell, or a PLMN associated with the first cell as depicted in step S1009.

Furthermore, the UE (200) continues to search for any other higher priority PLMN available in the wireless network system for selection that is not the first cell or continues to get services on the current second cell in the absence of any other higher priority PLMN that is not the first cell and can provide normal services.

Even when the UE (200) is registered with the first cell, the Timer T is monitored as illustrated at step S1011. On determining the expiration of the Timer T, the UE (200) initiates the search for a higher priority PLMN(i.e. follow the order of performing PLMN selection) that can provide S&F services to the UE (200) or the higher priority PLMN and lower priority PLMN that can provide normal services to the UE (200). In an embodiment, the UE (200) is configured to perform the search for the higher or lower priority cell capable of providing the normal service to the UE (200) even when the UE (200) is registered for a higher priority cell in response to determining that the UE (200) is registered on the first cell. In an embodiment, the UE (200) determines that the feeder link is unavailable when the network apparatus (201) broadcasts support of S&F mode, whereas when the network apparatus (201) does not broadcast support of S&F mode, then the UE (200) determines that the feeder link is available.

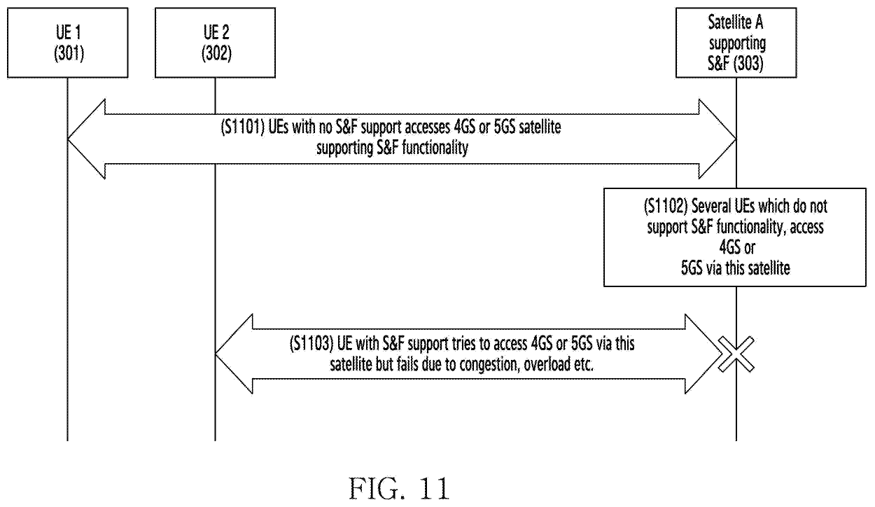

FIG. 11 is a signal flow diagram illustrating a scenario of the UE without S&F support accessing the cell that supports the S&F operation mode, according to the prior art. Several UE (301) which do not support S&F functionality for example Rel-18 or older UEs, or Rel-19 UE (301) which do not want to use S&F functionality, access 4GS or 5GS via a satellite, that supports S&F functionality. This can lead to a possibility of the satellite being overloaded or congested. Later when a UE (302) with S&F functionality tries to access 4GS or 5GS via the same satellite (303), it fails to access the core network due to congestion or overload.

For example, when several thousand UEs which do not support S&F functionality or do not want to use the S&F functionality are accessing 4GS or 5GS via satellite, it might lead to congestion either at the core network or at the satellite level. Later, when a UE that wants to use the S&F functionality tries to access 4GS or 5GS via the same satellite, such UE might not be able to access 4GS or 5GS due to congestion overload of the system and others.

At step S1101, the UE 1 (301), which does not support S&F operation mode, accesses the satellite A (303), which supports the S&F operation mode. The figure illustrates the multiple UEs which do not support S&F operation mode accessing the satellite A (303), which can lead to the possibility of the satellite A (303) being overloaded or congested (S1102). When the UE 2 (302), which supports S&F operation mode, tries to access the network through satellite A (303), the satellite A (303) fails to access the core network due to congestion or overload as illustrated at step S1103.

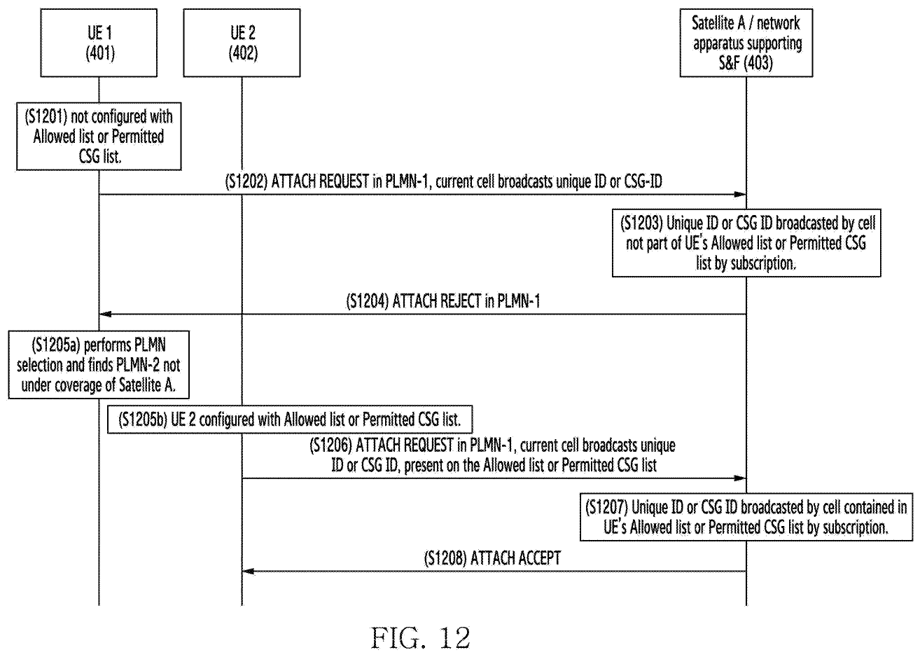

FIG. 12 is a signal flow diagram illustrating an example scenario of restriction of the UEs which do not support S&F functionality from accessing satellites which support S&F operation mode based on cell access according to various embodiments. Restricting the UEs which do not support S&F operation mode reduces the overload and the congestion of the satellite that provides S&F operation mode, which ensures the UEs which support S&F operation mode to access the satellite.

The cell broadcasted by the satellite (403) that supports S&F functionality will broadcast a unique identifier. This identifier can be a new unique identifier specific to satellite access for S&F(e.g. satellite ID or any any new identifier), or this can be the same identifier as CSG-ID of a cell. A UE (402) that supports S&F functionality will be configured with a list of such Allowed identifiers (in case of new identifier) per PLMN or SNPN, or a Permitted CSG list can be used to identify such satellite cells as in the case of CSG. For automatic PLMN or SNPN selection, a UE (402) supporting S&F feature will access a cell only if one of the unique identifiers (new identifier or CSG-ID) broadcasted by the cell is in the Allowed list or Permitted CSG list for that PLMN or SNPN configured in the UE. The network apparatus will have the subscription information for the UE (402) supporting S&F operation mode. Network apparatus will allow the UE to register in the network only if the subscription information of the UE indicates that one of the unique identifiers(for e.g. satellite IDs) or CSG-IDs broadcasted by the cell is in the Allowed list or the Permitted CSG list for that PLMN.

If the subscription of the UE in the network apparatus indicates that none of the unique identifiers or CSG-IDs broadcasted by the cell is in the Allowed list or the Permitted CSG list for that PLMN, or if the subscription indicates that the UE has no Allowed list or Permitted CSG list based on subscription, the network will reject the UE with a cause MM_cause, for example, #13, #15, #xx. On receiving this reject cause, the UE shall store the current TAI/cell in the forbidden list, for example, “forbidden tracking areas for roaming.” UE shall enter the state EMM-(DE)REGISTEREDLIMITED-SERVICE or optionally EMM-(DE)REGISTEREDPLMN-SEARCH, for example. The UE shall perform a PLMN selection/Cell selection/Cell reselection. This will ensure that the UE tries to find a different PLMN/cell/TAI, and the UE might find a PLMN/cell/TAI which does not fall under the coverage of such satellite supporting S&F. The TAI(s)/cell(s)/area supporting S&F and not supporting should be assigned different values.

The solution is applicable for all NAS messages, for example, ATTACH REQUEST, TRACKING AREA UPDATE REQUEST, REGISTRATION REQUEST, etc.

S1201 of FIG. 12 depicts the UE 1 (301) not configured with Allowed list or Permitted CSG list. Further, the UE 1 (301) sends an attach request to the satellite A (303) that supports S&F functionality in PLMN-1 while camped in a cell broadcasting one or more unique identifiers or CSG IDs as illustrated in step S1202. In step S1203 satellite A (403) determines that the unique ID or CSG ID broadcasted by the cell is not part of UE's Allowed list or Permitted CSG list by subscription. Attach/TAU/Registraiton request for such UE gets rejected by network apparatus with MM_cause in step S1204, for example, #13, #15, #xx, or any other suitable cause representing that this cell/TAI/PLMN is not allowed to access for the UE (401) as the UE (401) by subscription does not have any Allowed list or Permitted CSG list or does not have the S/F subscription. The UE 1 (401) performs PLMN selection, cell selection, or cell reselection, finds PLMN-2/cell-2 (e.g., of different CSG ID or unique identifier)/TAI-2 or different CSG IDs as illustrated at step S1205a. The UE 1 (401) will store the current camped TAI cell (or CSG ID) or PLMN in the forbidden list or remove it from the allowed list. Another UE 2 (402) that supports S&F functionality is configured with an Allowed list or Permitted CSG list. The UE 2 (402) tries to access the network while camped in a cell that broadcasts unique identifiers which are part of the Allowed list or CSG IDs configured in the Allowed CSG list in the UE 2 (402) in step 1205b. Unique ID or CSG ID broadcasted by the cell is contained in UE 2's allowed list or Permitted CSG list by subscription in the network. The Network accepts registration and sends a NAS message, for example, attach accept message to UE 2 (402) in step S1206.

The disclosure is described with ATTACH REQUEST as one of the possible possibilities but is not restricted to this alone; it can be other NAS messages as well. The solution is applicable in 5G as well, where the NAS message can be REGISTRATION REQUEST message but not limited to it.

In summary, the UE sends a NAS message to network apparatus (403) to access the network apparatus (403). The network apparatus (403) checks if the UE is accessing from a cell which is allowed for it to use for Store and forward operation (for example, using a unique identifier or the CSG ID or the CAG ID in subscription or based on local configuration) in step S1207, and if the UE is allowed to access the cell, then a positive NAS response, e.g., ATTACH ACCEPT in step S1208, is given to the UE; otherwise, a negative NAS response message like ATTACH REJECT with an appropriate cause is given to the UE. The UE performs PLMN selection, cell selection, or cell reselection and marks the current camped cell/TAI/PLMN as forbidden.

In an embodiment, adding into the forbidden list also implies removing it from the allowed list, and adding into the allowed list also implies removing it from the forbidden list (or blacklisted list or not permitted list). The forbidden list is a set/list of TAI, cell, CAG, or CSG, or any unique identifiers identifying the cell/TAI/CSG/CAG where UE is not allowed to select the cell, e.g., it is not a candidate for cell selection or reselection (i.e., it's not a suitable cell).

The allowed/permitted list is a set/list of TAI, cell, CAG, or CSG, or any unique identifiers identifying the cell/TAI/CSG/CAG where UE is allowed to select the cell, i.e., it is a candidate for cell selection or reselection (i.e., it's a suitable cell).

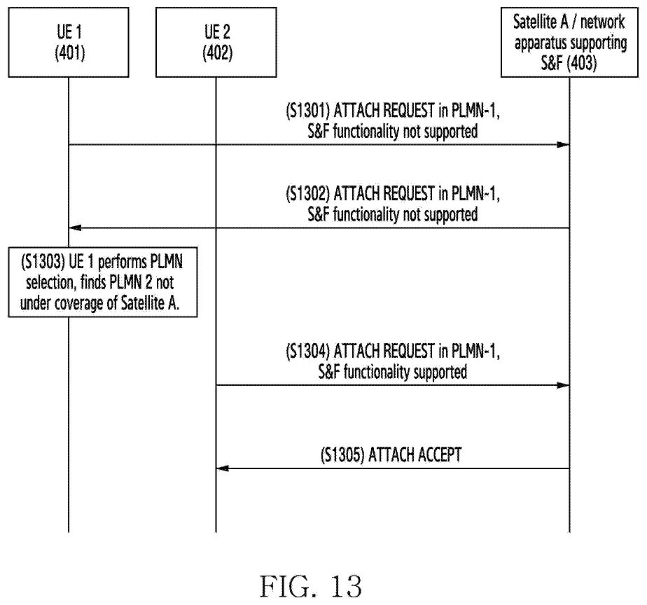

FIG. 13 is a signal flow diagram illustrating an example scenario of the network apparatus identifying the UE which supports the S&F operation mode based on the indication by the UE according to various embodiments.

The network apparatus (403) to be able to identify UEs which support S&F functionality, the UE shall indicate the support of the S&F functionality in NAS message to the network apparatus (403). This can be, for example, registration or attach procedure but not limited to these procedures or messages.

To restrict UEs which do not indicate support of S&F functionality (or intention to use S/F) from accessing satellites which support S&F (403), such a satellite will reject the UE with MM_cause, for example, #13 (Roaming not allowed in this tracking area), #14, or #15 or #xx, etc. On receiving this reject cause, the UE shall store the current TAI in the list of “forbidden tracking areas for roaming.” UE shall enter the state EMM-DEREGISTEREDLIMITED-SERVICE or optionally EMM-DEREGISTEREDPLMN-SEARCH, for example. The UE shall perform a PLMN selection, cell selection, or cell re-selection. This will ensure that the UE tries to find a different PLMN/TAI/cell, and the UE might find a PLMN which does not fall under the coverage of such satellite supporting S&F. If the UE indicates support of S&F operation mode to the satellite or network apparatus (403), the satellite (403) will allow such UE to access the satellite (403).

For example, Satellite A (403) has coverage of PLMN-1. UE 1 (401) not supporting S&F will not indicate the support for S&F to the network apparatus (403). Such a satellite (403) will reject such a UE (401) with cause MM_cause. That UE 1 (401) will perform PLMN selection, cell selection, or cell re-selection and might find PLMN-2 which does not come under the coverage of Satellite A (403). A UE 2 (402) supporting S&F will indicate the support of S&F in NAS message to Satellite A (403). Satellite A (403) will allow such a UE 2 (402) to access the satellite A (403) for normal services.

The S&F support from UE 2 (402) to the network apparatus (403) can be indicated in existing IEIs, for example, UE network capability in case of 4G or 5GMM capability in case of 5G, but not restricted to these 2 IEIs alone and can be any IEI where UE capability is indicated from UE to the network apparatus (403). This support can also be indicated in a new IEI from UE to network apparatus (403) in NAS messages, for example, but not limited to ATTACH REQUEST, TAU REQUEST in 4G, or REGISTRATION REQUEST in case of 5G.

Referring to step S1301, the UE 1 (401) not supporting S&F operation mode (or it supports S&F but does not intend to use S&F) sends attach request to network apparatus (403) that supports S&F functionality in PLMN-1 without the indication of support of S&F functionality/mode. Attach/TAU/registration request for such UE gets rejected by network (e.g., gNB or MME or AMF) with appropriate MM_cause, for example, #13, #14, or any new cause value #xx as depicted in step S1302. Then at S1303, the UE 1 (401) performs PLMN selection, cell selection, or cell reselection, finds PLMN-2/cell-2 (e.g., of different CSG ID or unique identifier)/TAI-2 or different CSG IDs. The UE 1 (401) will store the current camped TAI, Cell (or CSG ID), or PLMN in the forbidden list. Another UE 2 (402) that supports S&F functionality (and optionally intends to use S&F functionality) tries to access network apparatus (403) by indicating respectively support of S&F functionality (or intention to use S&F) in NAS message, for example, in ATTACH request or Registration request message in step S1304. The access gets accepted by the network apparatus (403) in step S1305. In summary, the UE indicates in a NAS message whether it intends to use S&F functionality; the network apparatus (403) accepts UEs access for S&F functionality; otherwise, network apparatus (403) will reject the UEs attach/access request.

In an embodiment, the ATTACH REQUEST is described as one of the possible possibilities but is not restricted to this alone; it can be other NAS messages as well. The solution is applicable in 5G as well, where the NAS message can be a REGISTRATION REQUEST message but is not limited to it.

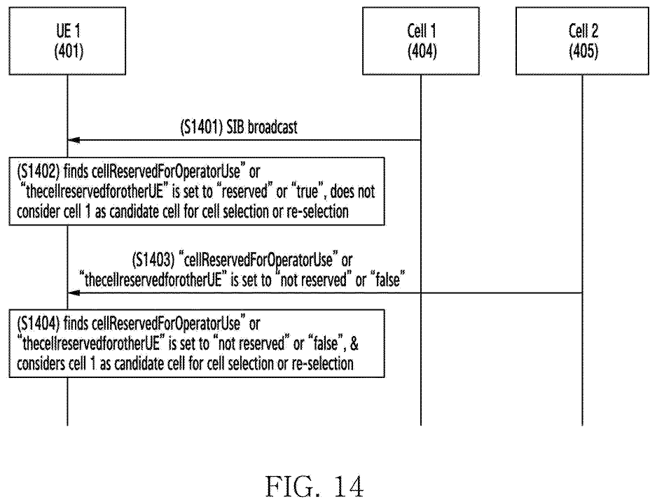

FIG. 14 is a signal flow diagram illustrating an example scenario where the UE with no S&F functionality is restricted from accessing the cell, which supports only S&F operation mode according to various embodiments. The restriction of access to 4GS or 5GS via satellite access will be at the cell/TAI/PLMN level. Cells that belong to satellites supporting S&F access will not allow UEs with no S&F support to access such cells at all.

A cell in its system information block (SIB) will provide an information element indicating that the cell is reserved for operator use/other UEs. In general this implies to all the UEs that the cell is barred to use the UE should not select such cells. Along with this information, the cell will also broadcast an information field indicating a set of unique identifiers per PLMN or SNPN. When old/legacy UEs, or the UEs which do not support S&F functionality, see that the information element indicating that the cell is reserved for operator use/other UEs is set to reserved or true for operator/other UEs, they will consider the cell to be barred/forbidden for them and not a candidate cell for cell selection or re-selection or PLMN selection procedure.

For UEs which support S&F functionality, when they see that the information element indicating that the cell is reserved for operator use/other UEs is set to true or reserved for operators/other UEs, and at the same time the information field indicating a set of unique identifiers per PLMN or SNPN is present and matches one or more unique identifiers per PLMN or SNPN configured in the UE, such UEs will consider this cell as a candidate cell for cell selection or re-selection.

For example, the information element indicating that the cell is reserved for operator use/other UEs can be using existing/new information elements such as cellReservedForOperatorUse or thecellreservedforotherUE. When this information element is true or reserved, for example, for old UEs which do not support S&F functionality, it will mean that the current cell is not a candidate cell for cell selection or re-selection its barred/forbidden for them.

For example, the information element indicating unique identifiers per PLMN or SNPN configured in the UE can be called Allowed list. The information element indicating unique identifiers broadcasted in the SIB per PLMN or SNPN can be called s&f-IdentityInfoList/satellite IDs etc. For UEs which support S&F functionality/understand S&F functionality, if cellReservedForOperatorUse or thecellreservedforotherUE is set to reserved or true and one or more unique identifiers per PLMN or SNPN broadcasted in the s&f-IdentityInfoList match one or more unique identifiers per PLMN or SNPN in the Allowed list in the UE, the UE will consider such a cell as a candidate cell for cell selection or re-selection.

An example use case can be described as: Cell A of PLMN A broadcasts: the information element “cellReservedForOperatorUse” or “thecellreservedforotherUE” which is set to: “reserved” or “true” for example.

Allowed list in the UE is configured with:
PLMN A, unique identifier say ID-A, ID-B.
PLMN B, unique identifier say ID-A, ID-C.

S&F-IdentityInfoList broadcasted by the cell is:
PLMN A, unique identifier say ID-A, ID-C.
PLMN C, unique identifier say ID-A, ID-D.

For the UE that does not support S&F functionality, it will see that “cellReservedForOperatorUse” or “thecellreservedforotherUE” is set to “true” and hence will not consider this cell as a candidate for cell selection or re-selection. Further for the UE that supports S&F functionality, it will see that “cellReservedForOperatorUse” or “thecellreservedforotherUE” is set to “true”, and unique ID-A for PLMN A in Allowed list, matches with unique ID-A for PLMN A broadcasted in s&f-IdentityInfoList, it will consider the call as a candidate for cell selection or re-selection.

The S&F identify info list is just used for illustration. This instead of having any list it can have an indication that UEs who wants to use S&F service and the UE can select this cell. e.g. it is a candidate cell for selection/reselection and its not barred/forbidden to the UE.

The S&F identify info list is just used for illustration. This instead of having any list it can have an indication that this cell is for S&F services or S&F mode and this can be accessed for S&F services.e i.e. it is a candidate cell for selection/reselection and its not barred/forbidden to the UE in S&F mode or the UE which wants to use S&F service.

Referring to FIG. 14 which illustrates the 2 cells in the area, one S&F only cell and one non S&F cell or a normal cell, and the UE 1 (401) that does not support S&F functionality. At 51401, the cell 1 (404) which is the S&F only cell or the cell which supports only the S&F service mode sends the SIB broadcast to the UE 1 (401). As part of the SIB broadcast, the cell 1 broadcasts: “cellReservedForOperatorUse” or “thecellreservedforotherUE” is set to “reserved” or “true”, and one or more unique identifiers per PLMN or SNPN broadcasted in the s&f-IdentityInfoList

Further at step S1402, the UE finds cellReservedForOperatorUse” or “thecellreservedforotherUE” is set to “reserved” or “true”, does not consider cell 1 as candidate cell for cell selection or re-selection. At S1403, the cell 2 (405) which supports normal services, as part of the SIB broadcast, broadcasts “cellReservedForOperatorUse” or “thecellreservedforotherUE” is set to “not reserved” or “false”. Further the UE 1 (401) finds cellReservedForOperatorUse” or “thecellreservedforotherUE” is set to “not reserved” or “false”, & considers cell 1 as candidate cell for cell selection or re-selection in step S1404. The figure illustrates how the UE (401) with no S&F functionality will be restricted to access an S&F only cell (404), but will be able to access a legacy non S&F cell(405) or a normal cell.

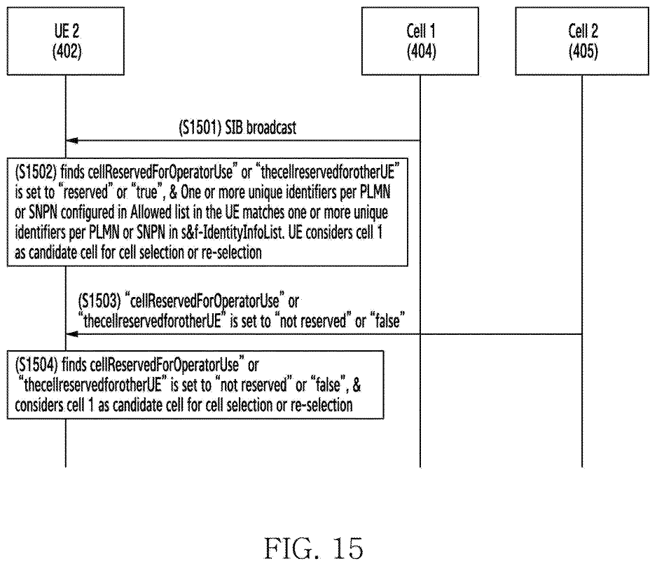

FIG. 15 is a signal flow diagram that illustrates the example scenario of the UE that supports S&F operation mode accessing both the cells supporting S&F operation modes and also the cells that support normal services according to various embodiments. FIG. 15 illustrates how the UE (402) with S&F functionality will be able to access an S&F only cell (404) and also a normal cell.

FIG. 15 illustrates the call flow between the UE 2 (402) which supports S&F operation mode, the cell 1 (404), and the cell 2 (405). At step S1501, the cell 1 (404) broadcasts the SIB broadcast where the cellReservedForOperatorUse or the cellreservedforotherUE is set to reserved or true and one or more unique identifiers per PLMN or SNPN broadcasted in the S&F-IdentityInfoList. Further, at 51502, the UE 2 (402) finds that the cellReservedForOperatorUse or the cellreservedforotherUE is set to reserved or true & one or more unique identifiers per PLMN or SNPN configured in the Allowed list in the UE matches one or more unique identifiers per PLMN or SNPN in s&f-IdentityInfoList. UE considers cell 1 as a candidate cell for cell selection or re-selection.

At step S1503, the cell 2 (405) broadcasts cellReservedForOperatorUse or the cellreservedforotherUE is set to not reserved or false as part of the SIB broadcast. Further, at step S1504, the UE 2 (402) finds cellReservedForOperatorUse or the cellreservedforotherUE is set to not reserved or false & considers cell 1 as a candidate cell for cell selection or re-selection.

In summary, the cell will broadcast the first identifier and second identifier. The first identifier will indicate that the cell is barred or not allowed to access to the UEs which do not support S&F mode/mechanism/UE sat UE communication features or in general this first identifier will indicate that this cell is barred/not accessible for all the UEs. For example, using cellReservedForOperatorUse or the cellreservedforotherUE is set to reserved or true. When the first identifier indicates as above, then UE support s/f mode or UE satellite UE communication or accessing using satellite access will also check the second identifier to see if this particular UEs are allowed to access (i.e., not barred) on this cell. If the second identifier (for example one or more unique identifiers per PLMN or SNPN configured in the Allowed list in the UE matches one or more unique identifiers per PLMN or SNPN in s&f-IdentityInfoList, CSG list, or CAG list or satellite IDs etc) indicates that S/F mode supporting UEs/UE satellite UE communication supporting UEs or UEs accessing via satellite access are allowed, then the respective UEs will consider this cell as a candidate for cell selection/reselection i.e., UE can camp and select the respective cell and trigger the NAS signaling. Otherwise, UE will not consider this as a candidate cell (i.e., select or reselect) the respective cell. The second indication can be an indication of support of S&F mode/operation from network which can be indicated to the UE using the methods discussed in this embodiment.

According to various example embodiments, a method performed by a user equipment (UE) in a wireless network system is provided. The method comprises determining whether a feeder link is unavailable on a first cell supporting a store & forward (S&F) mode; and in accordance with a determination that the feeder link is unavailable on the first cell, performing one of a public land mobile network (PLMN) selection, a cell selection, or a cell reselection in the wireless network system to search for a second cell capable of providing normal service to the UE.

According to various example embodiments, the method comprises determining whether the second cell capable of providing the normal service is identified; and camping and registering, by the UE, on the second cell in response to determining that the second cell is identified.

According to various example embodiments, the method comprises determining whether the second cell capable of providing the normal service is not identified; and camping and attaching on the first cell in response to determining that second cell is not identified.

According to various example embodiments, the method comprises determining whether a timer T expires, in case that the UE is registered for normal service on the second cell; initiating a search for a higher priority public land mobile network (PLMN), upon expiration of the timer T; determining whether a cell associated with the higher priority PLMN is the first cell; in case that the cell associated with the higher priority PLMN is the first cell, ignoring or skipping at least one of the first cell associated with the higher priority PLMN, a tracking area identifier (TAI) associated with the first cell, or a PLMN associated with the first cell; and performing one of continuing the search for any other higher priority PLMN available in the wireless network system for selection to identify a cell different from the first cell, and continuing to get services on the second cell, in absence of any other higher priority PLMN associated with a cell that is different from the first cell and can provide normal service.

According to various example embodiments, the method comprises determining whether a timer T expires, in case that the UE is on the first cell; initiating a search for a higher priority PLMN upon expiration of the timer T; and initiating a search for a higher priority PLMN that supports S&F mode of service to the UE or at least one of the higher priority PLMN or lower priority PLMN that can provide the normal service to the LE.

According to various example embodiments, the UE is configured to perform the search for the at least one of the higher or lower priority cell capable to provide the normal service to the UE.

According to various example embodiments, the determining whether the feeder link is unavailable on the first cell comprises determining that the feeder link is unavailable in accordance with a determination that the network apparatus broadcasts support of S&F mode; and determining that the feeder link is available in accordance with a determination that the network does not broadcast support of S&F mode.

According to various example embodiments, a method performed by a network apparatus for managing public land mobile network (PLMN) selection, cell selection or reselection for store and forward (S&F) modes in a wireless network system is provided. The method comprises determining whether a feeder link is available and the network apparatus supports the S&F mode; and performing, by the network apparatus, one of broadcasting, to a user equipment (UE), a signal message for indicating that the network apparatus is operating in the S&F mode, in accordance with a determination that the feeder link is unavailable and the network apparatus supports the S&F mode; and switching off functions of an evolved node base station (eNB) provided in the network apparatus and stopping broadcast of the signal message from the network apparatus, in accordance with a determination that the feeder link is unavailable and the network apparatus does not support the S&F mode.

According to various example embodiments the signal message is broadcasted through a system information block (SIB).

According to various example embodiments, a user equipment (UE) for managing public land mobile network (PLMN) selection, cell selection or reselection for store and forward (S&F) modes in a wireless network system is provided. The UE comprises at least one processor; and memory storing instructions that, when executed by the at least one processor individually or collectively, cause the UE to determine whether a feeder link is unavailable on a first cell supporting a store & forward (S&F) mode; and in accordance with a determination that the feeder link is unavailable on the first cell, performing one of a public land mobile network (PLMN) selection, a cell selection, or a cell reselection in the wireless network system to search for a second cell capable of providing normal service to the UE.

According to various example embodiments, the instructions that, when executed by the at least one processor individually or collectively, cause the UE to determine whether the second cell capable of providing the normal service is identified; and camp or register on the second cell in response to determining that the second cell is identified.

According to various example embodiments, the instructions that, when executed by the at least one processor individually or collectively, cause the UE to determine whether the second cell capable of providing the normal service is not identified; and camp and attach on the first cell in response to determining that second cell is not identified.

According to various example embodiments, the instructions that, when executed by the at least one processor individually or collectively, cause the UE to determine whether a timer T expires, in case that the UE is registered for normal services on a second cell; initiate a search for a higher priority PLMN, upon expiration of the timer T; determine whether a cell associated with the higher priority PLMN is the first cell; in case that the cell associated with the higher priority PLMN is the first cell, ignore or skip at least one of the first cell associated with the higher priority PLMN, a tracking area identifier (TAI) associated with the first cell, or a PLMN associated with the first cell; and perform one of continue to search for any other higher priority PLMN available in the wireless network system for selection to identify a cell different from the first cell, and continue to get services on the second cell, in absence of any other higher priority PLMN associated with a cell that is different from the first cell and can provide normal services.

According to various example embodiments, the instructions that, when executed by the at least one processor individually or collectively, cause the UE to: determine whether a timer T expires, when the UE is on the first cell; and initiate a search for a higher priority PLMN that can provide S&F services to the UE or at least one of the higher priority PLMN and lower priority PLMN that can provide normal services to the UE.

According to various example embodiments, the instructions that, when executed by the at least one processor individually or collectively, cause the UE to perform the search for the at least one of the higher or lower priority cell capable to provide the normal services to the UE.

The disclosure is equally applicable to UE not supporting Store and Forward or the UE not intending to use the store and forward feature or UE not supporting UE satellite UE communication or UE not intending to use the UE satellite UE communication feature and others.

The disclosure is explained using NR satellite access or Satellite NG-RAN Access Technology as an example and are not restricted or limited to NR Satellite access only. Further, the disclosure is also applicable for Satellite E-UTRAN access Technology NB (Narrow Band)-S1 mode or WB (Wide Band)-S1 mode via satellite E-UTRAN access and/or NB-IOT (Narrowband Internet of Things) or WB-IOT (Wideband Internet of Things) satellite access/architecture.

1) In an embodiment, IAB-UE is the part of the IAB node that supports the Uu interface towards the IAB-donor or another parent IAB-node (and thus manages the backhaul connectivity with either PLMN or SNPN it is registered with) is referred to as an IAB-UE. Where the Uu is the radio interface between the UE and the Node B.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

Abbreviations that may be used in the disclosure include those in Table 1 below:

TABLE 1

| | | |
|---|---|---|
| 1) | 3GPP | Third Generation Partnership Project |
| 2) | 4G-GUTI | 4G-Globally Unique Temporary Identifier |
| 3) | 5G-BRG | 5G Broadband Residential Gateway |
| 4) | 5GC | 5G Core |
| 5) | 5GCN | 5G Core Network |
| 6) | 5G-CRG | 5G Cable Residential Gateway |
| 7) | 5G-GUTI | 5G-Globally Unique Temporary Identifier |
| 8) | 5GMM | 5G Mobility Management |
| 9) | 5G-RG | 5G Residential Gateway |
| 10) | 5GS | 5G System |
| 11) | 5GSM | 5GS Session Management |
| 12) | 5G-S-TMSI | 5G S- Temporary Mobile Subscription Identifier |
| 13) | 5G-TMSI | 5G Temporary Mobile Subscription Identifier |
| 14) | 5QI | 5G QoS Identifier |
| 15) | ACS | Auto-Configuration Server |
| 16) | AKA | Authentication and Key Agreement |
| 17) | A-KID | AKMA Key Identifier |
| 18) | AKMA | Authentication and Key Management for Applications |
| 19) | AMBR | Aggregate Maximum Bit Rate |
| 20) | AMF | Access and Mobility Management Function |
| 21) | APN | Access Point Name |
| 22) | ARP | Allocation and Retention Policy |
| 23) | AS | Access Stratum |
| 24) | A-TID | AKMA Temporary Identifier |
| 25) | ATSSS | Access Traffic Steering, Switching and Splitting |
| 26) | AUSF | Authentication Server Function |
| 27) | CAG | Closed access group |
| 28) | CAG ID | Closed Access Group Identifier |
| 29) | CHAP | Challenge Handshake Authentication Protocol |
| 30) | CU | Centralized Unit |
| 31) | DC | Discontinuous Coverage |
| 32) | DisCo | Discontinuous Coverage |
| 33) | DL | Downlink |
| 34) | DND | Do not Disturb |
| 35) | DRX | Discontinuous Reception |
| 36) | DU | Distributed Unit |
| 37) | eDRX | Extended Discontinuous Reception |
| 38) | EHPLMN | Equivalent Home Public Land Mobile Network |
| 39) | EMM | EUTRA Mobility Management |
| 40) | eNB | Evolved Node-B |
| 41) | eNPN | Enhanced Non-Public Networks |
| 42) | EPC | Evolved Packet Core |
| 43) | EPLMN | Equivalent Public Land Mobile Network |
| 44) | EPS | Evolved Packet System |
| 45) | eSIM | embedded Subscriber Identity Module |
| 46) | E-UTRA | Evolved Universal Mobile Telecommunication Access |
| 47) | EUTRAN | Evolved Universal Mobile Telecommunication Access Network |
| 48) | FPLMN | Forbidden Public Land Mobile Network |
| 49) | FR | Frequency Range |
| 50) | GEO | Geostationary Orbit |
| 51) | GERAN | GSM Edge Radio Access Network |
| 52) | gNB | Next generation Node-B |
| 53) | gNB - CU | Next generation Node-B Control Unit |
| 54) | gNB - DU | Next generation Node-B Distributive Unit |
| 55) | GPRS | General Packet Radio Service |
| 56) | GPS | Global Positioning System |
| 57) | GSM | Global System for Mobile Communication |
| 58) | HPLMN | Home Public Land Mobile Network |
| 59) | IAB | Integrated access and backhaul |
| 60) | LADN | Local Area Data Network |
| 61) | LCS | Location services |
| 62) | LEO | Low Earth Orbit |
| 63) | MBSR | Mobile Base Station Relay |
| 64) | MCC | Mobile Country Code |
| 65) | MCS | Mission Critical Service |
| 66) | ME | Mobile Equipment |
| 67) | MEC | Multi-Access Edge Computing |
| 68) | MEO | Medium Earth Orbit |
| 69) | MICO | Mobile Initiated Communication Only |
| 70) | MINT | Minimization of service interruption |
| 71) | MME | Mobility Management Entity |
| 72) | MNC | Mobile Network Code |
| 73) | MPS | Multimedia Priority Service |
| 74) | MS | Mobile Station. |
| 75) | NAS | Non-Access Stratum |
| 76) | NB-S1 Mode | Narrow Band with S1 Interface |
| 77) | NGAP | Next Generation Application Protocol |
| 78) | NG-RAN | Next Generation Radio Access Network |
| 79) | NPN | Non-Public Networks |
| 80) | NR | New Radio |
| 81) | NTN | Non Terrestrial Networks |
| 82) | NW | Network |
| 83) | OOS | Out of Service |
| 84) | OSUpgrade | Operating System Upgrade |
| 85) | PDN | Packet Data Network |
| 86) | PDU | Packet Data Unit |
| 87) | PLMN ID | Public Land Mobile Network Identity |
| 88) | PSM | Power Saving Mode |
| 89) | QoS | Quality Of Service |
| 90) | RAT | Radio Access Technology |
| 91) | RPLMN | Registered Public Land Mobile Network |
| 92) | RRC | Radio Resource Control |
| 93) | RU | Registration Update |
| 94) | SAT | Satellite |
| 95) | SCAI | Satellite Coverage Availability Information |
| 96) | SIM | Subscriber Identity Module |
| 97) | SNPN | Standalone Non-Public Networks |
| 98) | SUCI | Subscription Concealed Identifier |
| 99) | SW | Software |
| 100) | TAC | Tracking Area Code |
| 101) | TAI | Tracking Area Identity |
| 102) | TAU | Tracking Area Update |
| 103) | TER | Terrestrial |
| 104) | TN | Terrestrial Networks |
| 105) | UCU | UE Configuration Update |
| 106) | UDM | Unified Data Management Function |
| 107) | UE | User Equipment |
| 108) | UL | Uplink |
| 109) | ULI | User Location Information |
| 110) | UPU | UE Parameters Update |
| 111) | USIM | Universal Subscriber Identification Module |
| 112) | VMR | Vehicle Mounted Relay |
| 113) | VPLMN | Visited Public Land Mobile Network |
| 114) | WB-S1 Mode | Wide Band with S1 Interface |

What is claimed is:

1. A method performed by a user equipment (UE) in a wireless network system, comprising:
determining whether a feeder link is unavailable on a first cell supporting a store & forward (S&F) mode; and
based on a determination that the feeder link is unavailable on the first cell, performing at least one of a public land mobile network (PLMN) selection, a cell selection, or a cell reselection in the wireless network system to search for a second cell capable of providing normal service to the UE.

2. The method of claim 1, further comprising:
determining whether the second cell capable of providing the normal service is identified; and
camping and registering, by the UE, on the second cell in response to determining that the second cell is identified.

3. The method of claim 1, further comprising:
determining whether the second cell capable of providing the normal service is not identified; and
camping and attaching on the first cell in response to determining that second cell is not identified.

4. The method of claim 1, further comprising:
determining whether a timer expires, based on the UE being registered for normal service on the second cell;
initiating a search for a higher priority public land mobile network (PLMN), upon expiration of the timer;
determining whether a cell associated with the higher priority PLMN is the first cell;
based on the cell associated with the higher priority PLMN being the first cell, ignoring or skipping at least one of the first cell associated with the higher priority PLMN, a tracking area identifier (TAI) associated with the first cell, or a PLMN associated with the first cell; and
performing at least one of:
continuing the search for any other higher priority PLMN available in the wireless network system for selection to identify a cell different from the first cell, and
continuing to get services on the second cell, in absence of any other higher priority PLMN associated with a cell that is different from the first cell and can provide normal service.

5. The method of claim 1, further comprising:
determining whether a timer expires, based on the UE being on the first cell;
initiating a search for a higher priority PLMN upon expiration of the timer; and
initiating a search for a higher priority PLMN that supports S&F mode of service to the UE or at least one of the higher priority PLMN or lower priority PLMN that can provide the normal service to the UE.

6. The method of claim 1, wherein the UE is configured to perform the search for the at least one of the higher or lower priority cell capable to provide the normal service to the UE.

7. The method of claim 1, wherein determining whether the feeder link is unavailable on the first cell comprises:
determining that the feeder link is unavailable based on a determination that the network apparatus broadcasts support of S&F mode; and
determining that the feeder link is available based on a determination that the network does not broadcast support of S&F mode.

8. A method performed by a network apparatus for managing public land mobile network (PLMN) selection, cell selection or reselection for store and forward (S&F) modes in a wireless network system, comprising:
determining whether a feeder link is available and the network apparatus supports the S&F mode; and
performing, by the network apparatus, at least one of:
broadcasting, to a user equipment (UE), a signal message indicating that the network apparatus is operating in the S&F mode, based on a determination that the feeder link is unavailable and the network apparatus supports the S&F mode; and
switching off functions of an evolved node base station (eNB) provided in the network apparatus and stopping broadcast of the signal message from the network apparatus, based on a determination that the feeder link is unavailable and the network apparatus does not support the S&F mode.

9. The method of claim 8, wherein the signal message is broadcast through a system information block (SIB).

10. A user equipment (UE) for managing public land mobile network (PLMN) selection, cell selection or reselection for store and forward (S&F) modes in a wireless network system, comprising:
at least one processor comprising processing circuitry; and
memory storing instructions, wherein at least one processor, individually or collectively, is configured to execute the instructions and to cause the UE to:
determine whether a feeder link is unavailable on a first cell supporting a store & forward (S&F) mode; and
based on a determination that the feeder link is unavailable on the first cell, performing at least one of a public land mobile network (PLMN) selection, a cell selection, or a cell reselection in the wireless network system to search for a second cell capable of providing normal service to the UE.

11. The UE of claim 10, wherein at least one processor, individually or collectively, is configured to cause the UE to:
determine whether the second cell capable of providing the normal service is identified; and
camp or register on the second cell in response to determining that the second cell is identified.

12. The UE of claim 10, wherein at least one processor, individually or collectively, is configured to cause the UE to:
determine whether the second cell capable of providing the normal service is not identified; and
camp and attach on the first cell in response to determining that second cell is not identified.

13. The UE of claim 10, wherein at least one processor, individually or collectively, is configured to cause the UE to:
determine whether a timer expires, based on the UE being registered for normal services on a second cell;
initiate a search for a higher priority PLMN, upon expiration of the timer;
determine whether a cell associated with the higher priority PLMN is the first cell;
based on the cell associated with the higher priority PLMN being the first cell, ignore or skip at least one of the first cell associated with the higher priority PLMN, a tracking area identifier (TAI) associated with the first cell, or a PLMN associated with the first cell; and
perform at least one of:
continue to search for any other higher priority PLMN available in the wireless network system for selection to identify a cell different from the first cell, and
continue to get services on the second cell, in absence of any other higher priority PLMN associated with a cell that is different from the first cell and can provide normal services.

14. The UE of claim 10, wherein at least one processor, individually or collectively, is configured to cause the UE to:
determine whether a timer expires, based on the UE being on the first cell; and
initiate a search for a higher priority PLMN that can provide S&F services to the UE or at least one of the higher priority PLMN and lower priority PLMN that can provide normal services to the UE.

15. The UE of claim 10, wherein at least one processor, individually or collectively, is configured to cause the UE to:
perform the search for the at least one of the higher or lower priority cell capable to provide the normal services to the UE.
